(19) United States
(12) Patent Application Publication
(10) Pub. No.: US 2009/0046212 A1
(43) Pub. Date: Feb. 19, 2009

(54) LIQUID CRYSTAL DISPLAY DEVICE AND TELEVISION RECEIVER

(76) Inventors: Toshihide Tsubata, Mie (JP); Mitsuaki Hirata, Mie (JP)

Correspondence Address: NIXON & VANDERHYE, PC, 901 NORTH GLEBE ROAD, 11TH FLOOR, ARLINGTON, VA, 22203, US

(21) Appl. No.: 12/095,869

(22) PCT Filed: Sep. 29, 2006
(86) PCT No.: PCT/JP2006/319501

§ 371 Date: Jun. 2, 2008

(30) Foreign Application Priority Data
Jan. 30, 2006 (JP) 2006-021101

(51) Int. Cl. H04N 9/30; G02F 1/1343; G02F 1/1335

(52) U.S. Cl. 348/790; 349/139; 349/96; 348/E09.024

(57) ABSTRACT

A liquid crystal display device of the present invention combines two active matrix type liquid crystal panels (a first panel and a second panel). A data signal wiring (4) of each panel is formed by a transparent conductive film, and an island-like black matrix (24) is formed so as to cover a TFT element (3). By such structure, a moire which markedly occurs when combining two or more active matrix type liquid crystal panels is restrained, and the transmittance is improved. Thus, a high display quality liquid crystal display device is provided.

### TECHNICAL FIELD

The present invention relates to a liquid crystal display device with improved contrast, and a television receiver incorporating such a device.

### BACKGROUND ART

There exist various techniques for improving the contrast of a liquid crystal display device. The following is examples disclosed in Patent Documents 1 through 7.

Patent Document 1 discloses a technique of improving a contrast ratio by appropriately setting the content and the specific surface area of a yellow pigment in a color filter. According to this technique, it is possible to improve the problem that the contrast ratio of a liquid crystal display device is reduced, by the fact that pigment molecules of the color filter scatter and depolarize polarized light. The technique disclosed in Patent Document 1 reveals that the contrast ratio of a liquid crystal display device improves from 280 to 420.

Patent Document 2 discloses a technique of improving a contrast ratio by increasing the transmittance and the polarization degree of a polarization plate. The technique disclosed in Patent Document 2 reveals that the contrast ratio of a liquid crystal display device improves from 200 to 250.

Patent Documents 3 and 4 disclose a technique for improving contrast in a guest-host type which exploits a light-absorbing property which a dichroic pigment has.

Patent Document 3 describes a method for improving contrast by a structure in which a quarter-wave plate is sandwiched between two guest-host liquid crystal cells. Patent Document 3 discloses that a polarization plate is not used.

Patent Document 4 discloses a liquid crystal display element in which a dichroic pigment is mixed with a liquid crystal used in a dispersed liquid crystal type. Patent Document 4 discloses a contrast ratio of 101.

The techniques disclosed in Patent Documents 3 and 4, however, show lower contrast than those of the other Patent Documents. To further improve the contrast, it is necessary to take various measures: an improvement in the light-absorbing property of the dichroic pigment, an increase in the content of pigment, and an increase in the thickness of the guest-host liquid crystal cell(s). All these measures, however, would lead to new technical problems, such as a poor reliability and a poor response property.

Each of Patent Documents 5 and 6 discloses a method for improving contrast by an optical compensation type in which a liquid crystal panel and a liquid crystal display panel are provided between a pair of polarization plates. The liquid crystal panel performs optical compensation.

In Patent Document 5, a retardation contrast ratio improves from 14 to 35 in an STN type. The STN type includes a display cell and a liquid crystal cell for optical compensation.

In Patent Document 6, a contrast ratio is improved from 8 to 100 by disposing a liquid crystal cell for optical compensation. The liquid crystal cell compensates for wavelength dependence of a liquid crystal display cell of, for example, TN type, which wavelength dependence occurs while the display cell is displaying black.

Although the techniques disclosed in the Patent Documents achieve a 1.2 to 10 fold or even greater increase in contrast ratio, the absolute value of contrast ratio is in a range of about 35 to 420.

Another contrast enhancing technique is disclosed in Patent Document 7, for example. The document teaches a complex liquid crystal display device in which two liquid crystal panels are stacked whose polarization plates form crossed Nicols. Patent Document 7 discloses that the combining of two panels increases the contrast ratio up to three to four digit values whilst the panel, if used alone, merely shows a contrast ratio of 100.

### Patent Document 1

Japanese Unexamined Patent Publication, Tokukai, No. 2001-188120 (published on Jul. 10, 2001)

### Patent Document 2

Japanese Unexamined Patent Publication, Tokukai, No. 2002-90536 (published on Mar. 27, 2002)

### Patent Document 3

Japanese Unexamined Patent Publication, Tokukaisho, No. 63-25629 (published on Feb. 3, 1988)

### Patent Document 4

Japanese Unexamined Patent Publication, Tokukaihei, No. 5-2194 (published on Jan. 8, 1993)

### Patent Document 5

Japanese Unexamined Patent Publication, Tokukaisho, No. 64-49021 (published on Feb. 23, 1989)

### Patent Document 6

Japanese Unexamined Patent Publication, Tokukaihei, No. 2-23 (published on Jan. 5, 1990)

### Patent Document 7

Japanese Unexamined Patent Publication, Tokukaihei, No. 5-88197 (published on Apr. 9, 1993)

### DISCLOSURE OF INVENTION

Patent Document 7 aims at achieving an increase in gray levels by combining two liquid crystal panels without increasing the gray levels of the individual liquid crystal panels. As such, no concrete measures are taken to address moire problems. Therefore, display quality could seriously degrade.

The present invention is made in view of the problems, and an objective thereof is to realize a liquid crystal display device with high display quality, by reducing moire occurrences which markedly increase when two liquid crystal panels are combined.

In order to solve the problems, a liquid crystal display device in accordance with the present invention is characterized in that, in a liquid crystal display device in which two or more active matrix type liquid crystal panels are combined, at least one of the two or more liquid crystal panels includes signal wiring made of a transparent conductive film.

According to the arrangement, it is possible to restrain the change in light transmittance caused by a displacement when liquid crystal panels are combined. More specifically, structures (signal wiring in this case) whose light transmittance change periodically generate when active matrix liquid crystal display panels are combined. The arrangement however enables to restrain interference of the structures. As a result, the moire occurrences caused by the change in light transmittance is reduced.

In addition, the light transmittance naturally decreases when the liquid crystal panels are combined. However, the use of a transparent conductive film to form the signal wiring enables to increase an aperture ratio. As a result, light transmittance is improved.

Therefore, at least two problems, (i) the moire occurrence and (ii) the decrease in transmittance, each of which occur when the liquid crystal panels are combined, are solved by forming the signal wiring of the liquid crystal panel by using the transparent conductive film. Thus, a high display quality image is attained.

In addition, two of the active matrix type liquid crystal panels may be combined, and at least one of the two or more liquid crystal panels may include signal wiring made of transparent electrode.

In this case, a constituent of the signal wiring which is the cause for the periodical change in light transmittance is reduced in one of the liquid crystal panels. Thus, the moire occurrence is reduced.

Furthermore, a signal wiring made of a light blocking metal can form a more low resistance wiring compared to a common transparent wiring. Therefore, for example, by forming the signal wiring of one liquid crystal panel by using a transparent electrode, and forming the signal wiring of the other panel by using the light blocking metal, it is possible to lower the driver voltage. Thus, a low cost driver can be used.

Polarized light absorbing layers may be provided sandwiching each of the liquid crystal panels, in which the polarized light absorbing layers form crossed Nicols.

In this case, in the front direction, light leaks from a transmission axis of a polarized light absorbing layer, however the leak is eliminated by the absorption axis of the next polarized light absorbing layer. At oblique angles, if the Nicol angle, the angle at which the polarization axes of the adjacent polarized light absorbing layers intersect, deviates somewhat from an original design, no increase in light intensity due to light leakage occurs. That is, black is less likely to lose its depth with an increase in the Nicol angle at oblique viewing angles.

When two or more liquid crystal panels are combined, and polarized light absorbing layers are disposed sandwiching the liquid crystal panels to form crossed Nicols as above, at least three polarized light absorbing layers are included. The three polarized light absorbing layers disposed to form crossed Nicols allow for an improved shutter performance both in the front and oblique directions. That in turn greatly improves contrast. The contrast is further improved by performing display on the basis of a display signal, on the combined plurality of liquid crystal panels, respectively.

The liquid crystal display device of the present invention is preferable such that a light blocking layer is formed on an upper part and/or a lower part of a switching element of an active matrix substrate which constitutes each of the liquid crystal panel.

Thus, a leak current caused by a light irradiation is reduced with respect to a switching element such as a TFT element. The TFT element is formed on an active matrix substrate.

The liquid crystal display device of the present invention may be used as a display device included in a television receiver, the television receiver including: a tuner section that receives television broadcast; and a display device that displays the television broadcast received by the tuner section.

### BRIEF DESCRIPTION OF DRAWINGS

FIG. 1 illustrates an embodiment of the present invention, and is a schematic cross sectional view of a liquid crystal display device.

FIG. 2 is an explanatory drawing illustrating a positional relationship between polarization plates and panels in the liquid crystal display device illustrated in FIG. 1.

FIG. 3 is a plan view illustrating the vicinity of a pixel electrode in the liquid crystal display device illustrated in FIG. 1.

FIG. 4 is a schematic structural diagram illustrating a drive system which drives the liquid crystal display device illustrated in FIG. 1.

FIG. 5 illustrates an explanatory drawing illustrating how drivers and panel drive circuits are connected to each other in the liquid crystal display device illustrated in FIG. 1.

FIG. 6 is a schematic structural diagram illustrating a backlight provided in the liquid crystal display device illustrated in FIG. 1.

FIG. 7 is a block diagram illustrating a display controller serving as a drive circuit which drives the liquid crystal display device illustrated in FIG. 1.

FIG. 8 is a schematic cross sectional view illustrating a liquid crystal display device having a single liquid crystal panel.

FIG. 9 is an explanatory drawing illustrating a positional relationship of polarization plates and panels in the liquid crystal display device illustrated in FIG. 8.

FIG. 10(a) is an explanatory drawing illustrating a principle of improvement in contrast.

FIG. 10(b) is an explanatory drawing illustrating a principle of improvement in contrast.

FIG. 10(c) is an explanatory drawing illustrating a principle of improvement in contrast.

FIG. 11(a) is an explanatory drawing illustrating a principle of improvement in contrast.

FIG. 11(b) is an explanatory drawing illustrating a principle of improvement in contrast.

FIG. 11(c) is an explanatory drawing illustrating a principle of improvement in contrast.

FIG. 11(d) is an explanatory drawing illustrating a principle of improvement in contrast.

FIG. 12(a) is an explanatory drawing illustrating a principle of improvement in contrast.

FIG. 12(b) is an explanatory drawing illustrating a principle of improvement in contrast.

FIG. 12(c) is an explanatory drawing illustrating a principle of improvement in contrast.

FIG. 13(a) is an explanatory drawing illustrating a principle of improvement in contrast.

FIG. 13(b) is an explanatory drawing illustrating a principle of improvement in contrast.

FIG. 14(a) is an explanatory drawing illustrating a principle of improvement in contrast.

FIG. 14(b) is an explanatory drawing illustrating a principle of improvement in contrast.

FIG. 14(c) is an explanatory drawing illustrating a principle of improvement in contrast.

FIG. 15(a) is an explanatory drawing illustrating a principle of improvement in contrast.

FIG. 15(b) is an explanatory drawing illustrating a principle of improvement in contrast.

FIG. 16(a) is an explanatory drawing illustrating a principle of improvement in contrast.

FIG. 16(b) is an explanatory drawing illustrating a principle of improvement in contrast.

FIG. 17 illustrates another embodiment of the present invention, and is a schematic cross sectional view illustrating a liquid crystal display device.

FIG. 18 is a plan view illustrating a pixel of the liquid crystal display device illustrated in FIG. 17.

FIG. 19 is a plan view illustrating another example of a pixel of the liquid crystal display device illustrated in FIG. 17.

FIG. 20 is an explanatory drawing illustrating one example of a black matrix formation position.

FIG. 21 is an explanatory drawing illustrating another example of a black matrix formation position.

FIG. 22 is an explanatory drawing illustrating a further example of a black matrix formation position.

FIG. 23 is a schematic block diagram illustrating a television receiver in which a liquid crystal display device of the present invention is incorporated.

FIG. 24 is a block diagram illustrating a relationship between a tuner section and a liquid crystal display device in the television receiver illustrated in FIG. 23.

FIG. 25 is an exploded perspective view illustrating the television receiver illustrated in FIG. 23.

### BEST MODE FOR CARRYING OUT THE INVENTION

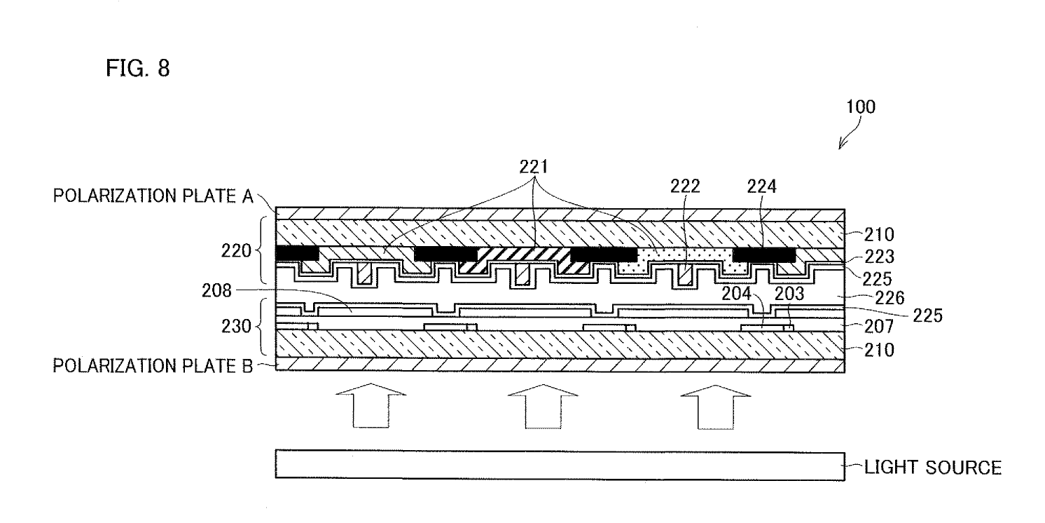

A typical liquid crystal display device is arranged so that polarization plates A and B are combined with a liquid crystal panel including a color filter substrate and a substrate for drive-use, as illustrated in FIG. 8. The description here will focus on an MVA (Multidomain Vertical Alignment) liquid crystal display device.

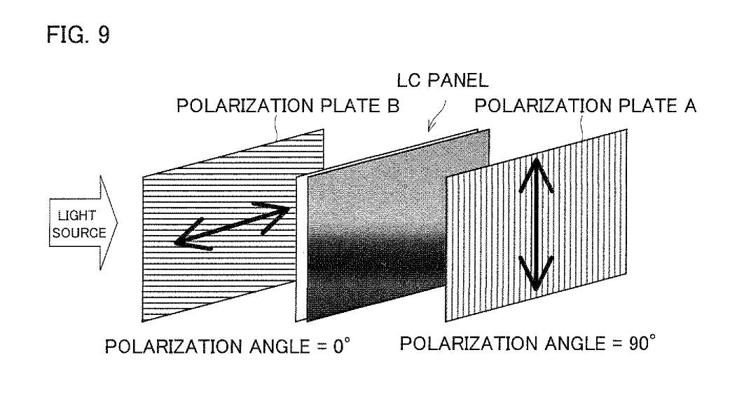

The polarization plates A and B, as illustrated in FIG. 9, have polarized light axes orthogonal to each other. A direction in which the liquid crystal is inclined while a threshold voltage is applied to a pixel electrode 208 (see FIG. 8) is set to have an angle of direction of 45° with respect to the polarized light axes of the polarization plates A and B. Under these conditions, the polarization axis rotates when an incident light on the polarization plate A passes through a liquid crystal layer in the liquid crystal panel. This allows the light to pass through the polarization plate B. When a voltage applied to the pixel electrodes is not more than the threshold voltage, the liquid crystal aligns vertically to the substrate. This causes the polarization angle of the incident light not to be changed, thereby resulting in that a black display is carried out. In an MVA type, a wide viewing angle is realized by dividing a direction in which the liquid crystal falls into four (Multidomain).

Vertical alignment indicates a state in which an axis (axis orientation) of liquid crystal molecules aligns at about an angle of not less than 85° with respect to the surface of a vertical alignment film.

In the case of a two-polarization-plate structure as illustrated in FIG. 9, there is a limit to a contrast improvement. The inventors of the present application found that the shutter performances improved both in the front direction and in an oblique direction, by adopting a three-polarization-plate structure for two liquid crystal display panels (each polarization plate being arranged to form crossed Nicols).

The following discusses a principle of an improvement in contrast.

Specifically, the inventors have made the following findings.

### (1) Front Direction

The depolarization (scattering of CF, for example) in a panel caused light to be leaked from the transmission axis of crossed Nicols. When adopting a three-polarization-plate structure in which first through third polarization plates are provided, it is possible to eliminate the light leaked in a direction of the transmission axis of the second polarization plate, by bringing a direction of the absorption axis of the third polarization plate into line with the direction of the transmission axis of the second polarization plate. The leakage is thus eliminated.

### (2) Oblique Directions

A change in amount of light leakage becomes insensitive to a change in Nicol angle φ of a polarization plate, that is, black is less likely to lose its depth in response to the breadth of Nicol angle φ at an oblique viewing angle.

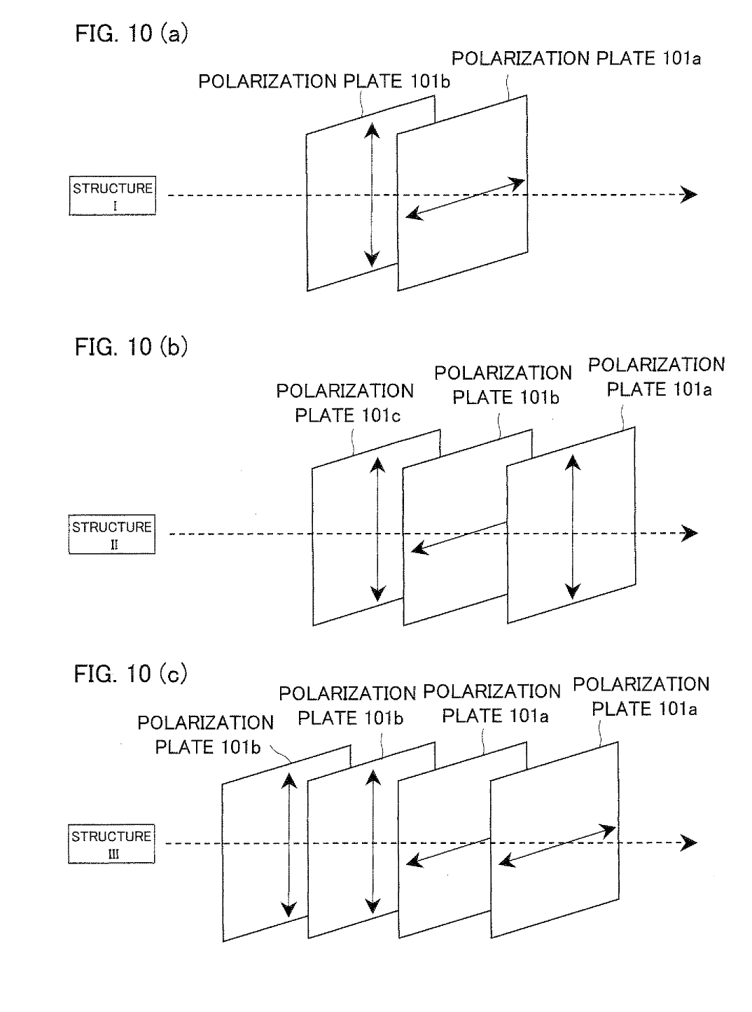

Based on the above (1) and (2), the inventors found that the contrast of the liquid crystal display device was greatly improved. The following description deals with a principle of an improvement in contrast with reference to FIGS. 10(a) through 10(c), FIGS. 11(a) through 11(d), FIGS. 12(a) through 12(c), FIGS. 13(a) and 13(b), FIGS. 14(a) through 14(c), FIGS. 15(a) and 15(b), FIGS. 16(a) and 16(b), and Table 1. Hereinafter, a two-polarization-plate structure is referred to as structure I, and a three-polarization-plate structure is referred to as structure II. A contrast improvement in an oblique direction is attributable essentially to polarization plate structure. The modeling here is based only on polarization plates, involving no liquid crystal panel.

FIG. 10(a) depicts, assuming a case where a single liquid crystal display panel is provided in structure I, an example of two polarization plates 101a and 101b disposed to form crossed Nicols. FIG. 10(b) depicts an example of three polarization plates 101a, 101b and 101c disposed to form crossed Nicols in structure II. Since structure II assumes the case in which two liquid crystal display panels are provided, there are two pairs of polarization plates which are disposed to form crossed Nicols. FIG. 10(c) depicts an example of a polarization plate 101a and a polarization plate 101b disposed face to face to form crossed Nicols; another polarization plate having the same polarization direction is disposed outside each of the polarization plates. Although FIG. 10(c) shows an arrangement in which four polarization plates are provided, the number of polarization plates that form crossed Nicols is two, in cases where a single crystal display panel is sandwiched between the polarization plates.

A transmittance which a liquid crystal display panel has when producing a black display is modeled by treating such a transmittance as a cross transmittance which is obtained when polarization plates are disposed to form crossed Nicols without a liquid crystal display panel, which model is hereinafter referred to as a black display. Similarly, a transmittance which a liquid crystal display panel has when producing a white display is modeled by treating such a transmittance as a parallel transmittance which is obtained when polarization plates are disposed to form parallel Nicols without a liquid crystal display panel, which model is hereinafter referred to as a white display. FIGS. 11(a) through 11(d) are graphs each illustrating an example of a relationship between wavelength and transmittance of a transmission spectrum obtained when the polarization plates are viewed from a front surface or viewed at an oblique angle. The modeled transmittance is an ideal value of the transmittance of the white display or of the black display in an arrangement where polarization plates disposed to form crossed Nicols between which the liquid crystal display panel is sandwiched.

FIG. 11(a) is a graph showing a relationship between wavelength and cross transmittance of a transmission spectrum obtained when the polarization plates are viewed from the front surface. In FIG. 11(a), structures I and II are shown for comparison. The graph demonstrates that structures I and II exhibit similar transmittance characteristics when a black display is viewed from the front surface.

FIG. 11(b) is a graph showing a relationship between wavelength and parallel transmittance of a transmission spectrum obtained when the polarization plates are viewed from the front surface. In FIG. 11(b), structures I and II are shown for comparison. The graph demonstrates that structures I and II exhibit similar transmittance characteristics obtained when a white display is viewed from the front surface.

FIG. 11(c) is a graph showing a relationship between wavelength and cross transmittance of a transmission spectrum obtained when the polarization plates are viewed at an oblique angle (angle of direction=45°, —polar angle 60°). In FIG. 11(c), structures I and II are shown for comparison. The graph demonstrates that when a black display is viewed at an oblique angle, structure II exhibits an almost zero transmittance at many of the wavelengths shown, whereas structure I transmits a small amount of light for almost over the entire wavelength range. To put it differently, a light leakage (a deterioration in black crispness) occurs in the two-polarization-plate structure, when a black display is viewed at an oblique viewing angle. On the other hand, a light leakage (a deterioration in black crispness) is restrained in the three-polarization-plate structure, when a black display is viewed at oblique viewing angles.

FIG. 11(d) is a graph showing a relationship between wavelength and parallel transmittance of a transmission spectrum obtained when the polarization plates are viewed at an oblique angle (angle of direction=45°, —polar angle 60°). In FIG. 11(d), structures I and II are shown for comparison. The graph demonstrates that structures I and II exhibit similar transmittance characteristics obtained when a white display is viewed at an oblique angle.

As shown in FIGS. 11(b) and 11(d), in the white display, substantially the same transmittance characteristics are shown regardless of whether the polarization plates are viewed from the front surface or viewed at an oblique angle. There is no substantial difference in the transmittance characteristics due to the number of the polarization plates, in other words, due to the number of crossed Nicols pairs of the polarization plates.

However, as shown in FIG. 11(c), in the black display, a deterioration in black crispness occurs when the black display is viewed at an oblique angle, in structure I in which a single crossed Nicols pair is provided, whereas a deterioration in black crispness is restrained when the black display is viewed at an oblique angle, in structure II in which two crossed Nicols pairs are provided.

Table 1 shows, as an example, a transmittance relationship between (i) the case where the polarization plates are viewed from the front surface and (ii) the case where the polarization plates are viewed at an oblique angle (angle of direction=45°, —polar angle 60°), when the wavelength of the transmission spectrum is 550 nm.

TABLE 1

| | Front | | | Oblique position (45°, −60°) | | |
|---|---|---|---|---|---|---|
| | Structure | Structure | | Structure | Structure | |
| | I | II | II/I | I | II | II/I |
| Parallel | 0.319 | 0.265 | 0832 | 0.27449 | 0.219084 | 0.798 |
| Crossed | 0.000005 | 0.000002 | 0.4 | 0.01105 | 0.000398 | 0.0360 |
| Parallel/ | 63782 | 132645 | 2.1 | 24.8 | 550.5 | 22.2 |
| Crossed | | | | | | |

In Table 1, “Parallel” denotes parallel transmittance, i.e., denotes the transmittance in white display, and “Cross” denotes cross transmittance, i.e., denotes the transmittance in black display. As such, “Parallel/Cross” denotes contrast.

Table 1 demonstrates that the contrast obtained when a display is viewed from the front surface in structure II is about twice as high as that in structure I. Table 1 also demonstrates that the contrast obtained when the display is viewed at an oblique angle in structure II is about 22 times as high as that in structure I. The contrast obtained when the display is viewed at an oblique angle shows great improvements.

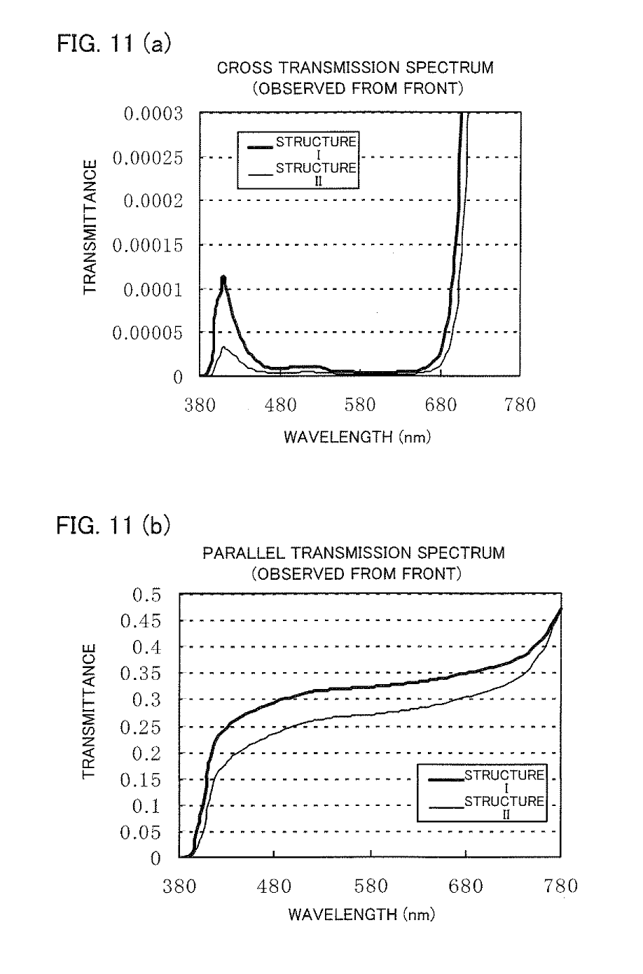

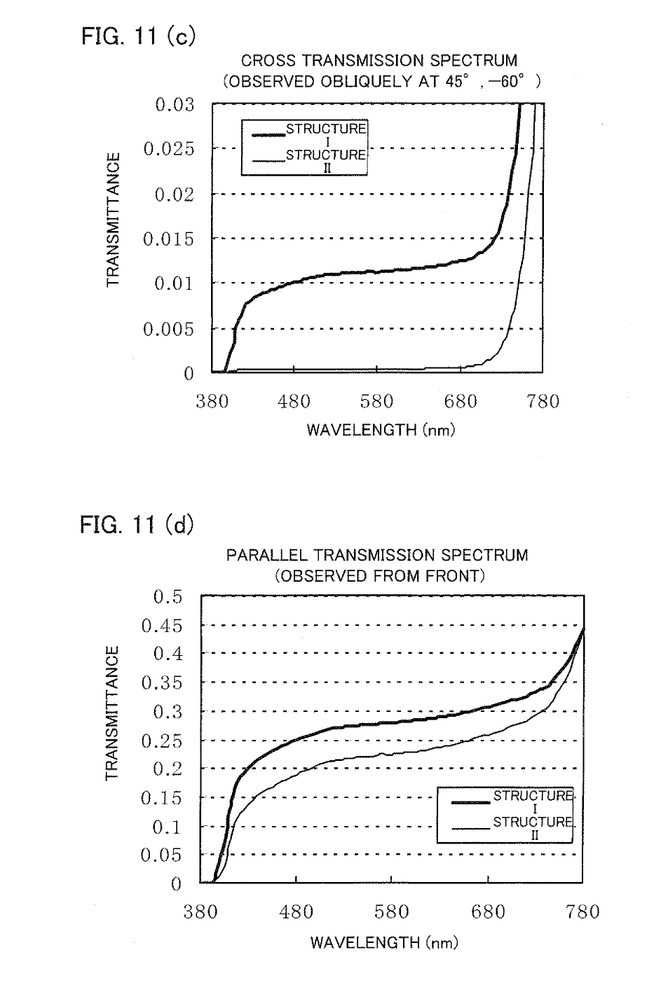

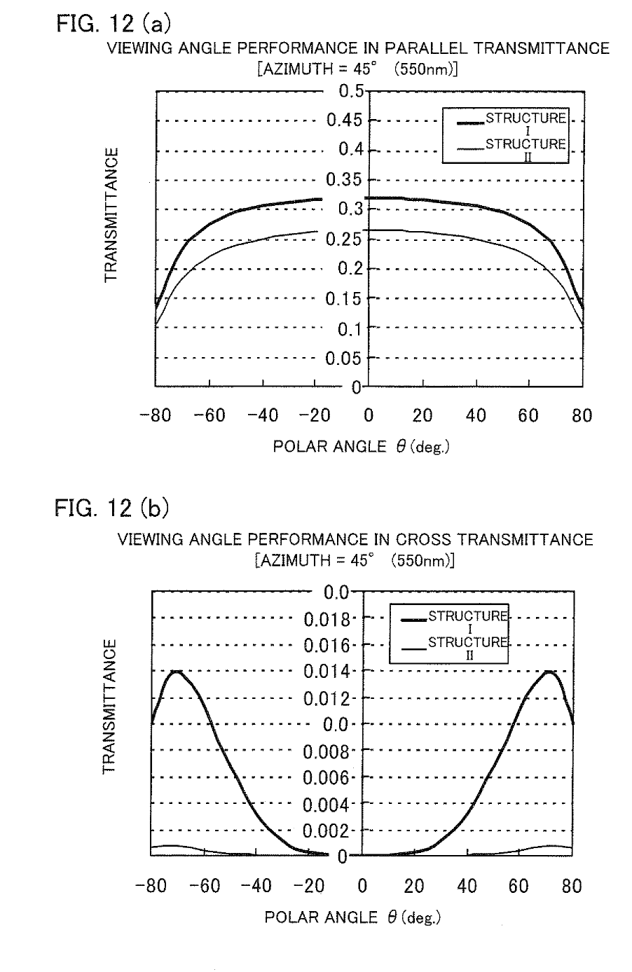

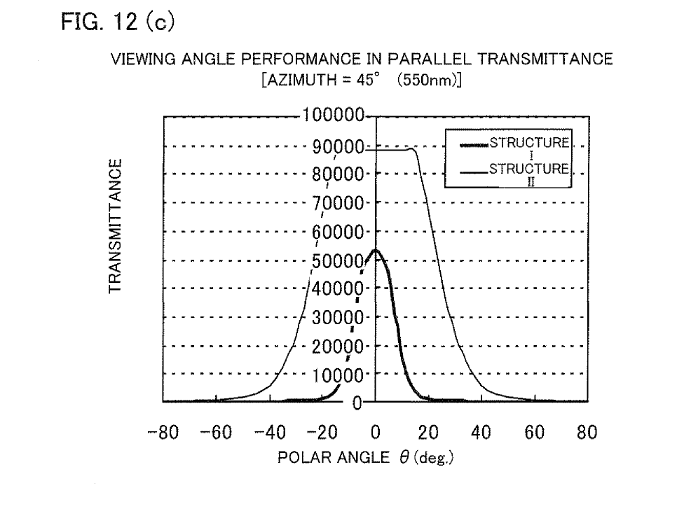

Now, referring to FIGS. 12(a) through 12(c), viewing angle characteristics will be described for white display and black display. The following describes the case where an angle of direction is 45° with respect to polarization plates and a wavelength of a transmittance spectrum is 550 nm.

FIG. 12(a) is a graph representing a relationship between a polar angle and transmittance in white display. The graph demonstrates that structures I and II have similar viewing angle characteristics (parallel viewing angle characteristics), although structure II exhibits a lower transmittance than structure I across the entire range.

FIG. 12(b) is a graph representing a relationship between a polar angle and transmittance in black display. The graph demonstrates that structure II restrains the transmittance at an oblique viewing angle (in the vicinity of polar angle of ±80°). On the other hand, structure I exhibits that the transmittance increases at an oblique viewing angle. Namely, FIG. 12(b) shows that a deterioration in black crispness occurs more remarkably in structure I than in structure II.

FIG. 12(c) is graph representing a relationship between a polar angle and contrast. The graph demonstrates that structure II exhibits far better contrast than structure I. In the vicinity of a polar angle of 0°, the characteristic of structure II in FIG. 12(c) is shown as flat because no calculation can be carried out due to cancellation of significant digits caused by the smallness of black transmittance. The actual characteristic in the vicinity of a polar angle of 0° however is a smooth curve.

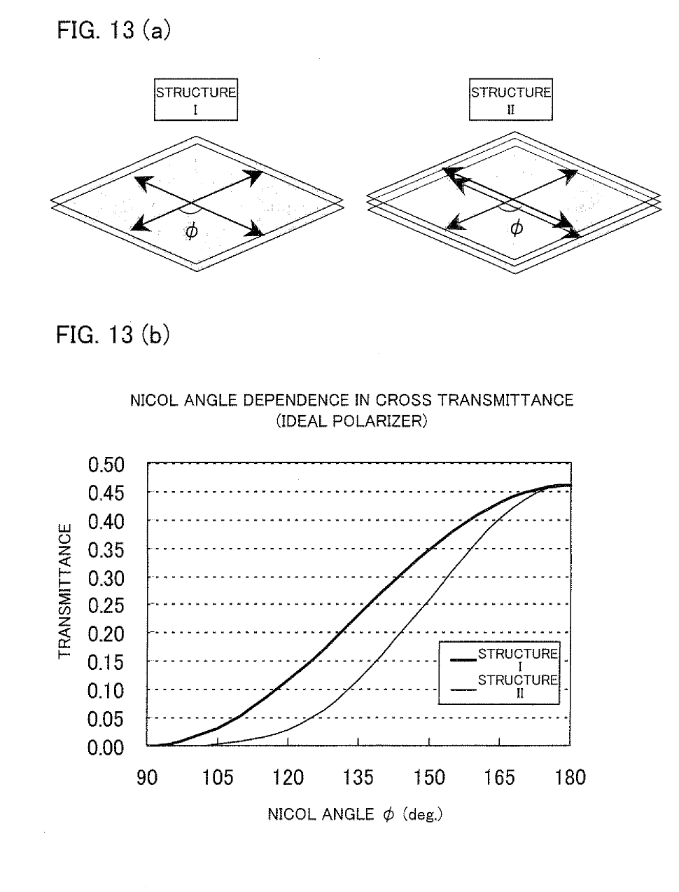

The following is a description of the phenomenon that a change in amount of light leakage becomes insensitive to a change in Nicol angle φ of a polarization plate, that is, black is less likely to lose its depth in response to the breadth of Nicol angle φ at an oblique viewing angle, with reference to FIGS. 13(a) and 13(b). The polarization plate Nicols angle φ is defined as an angle between the polarization axes of opposed polarization plates, which polarization axes are in a torsion state, as illustrated in FIG. 13(a). FIG. 13(a) is a perspective view illustrating the polarization plates positioned to form crossed Nicols. FIG. 13(a) shows a Nicols angle φ which deviates from 90° (the deviation varies depending on a change in the Nicols angle).

FIG. 13(b) is a graph representing a relationship between a Nicols angle φ and cross transmittance. Calculations are carried out based on an ideal polarizer (parallel Nicols transmittance=50%; crossed Nicols transmittance=0%). In the black display, the graph demonstrates that the transmittance changes less with respect to a change in the Nicols angle φ in structure II than in structure I. In other words, the three-polarization-plate structure is less affected by a change in the Nicols angle φ than the two-polarization-plate structure.

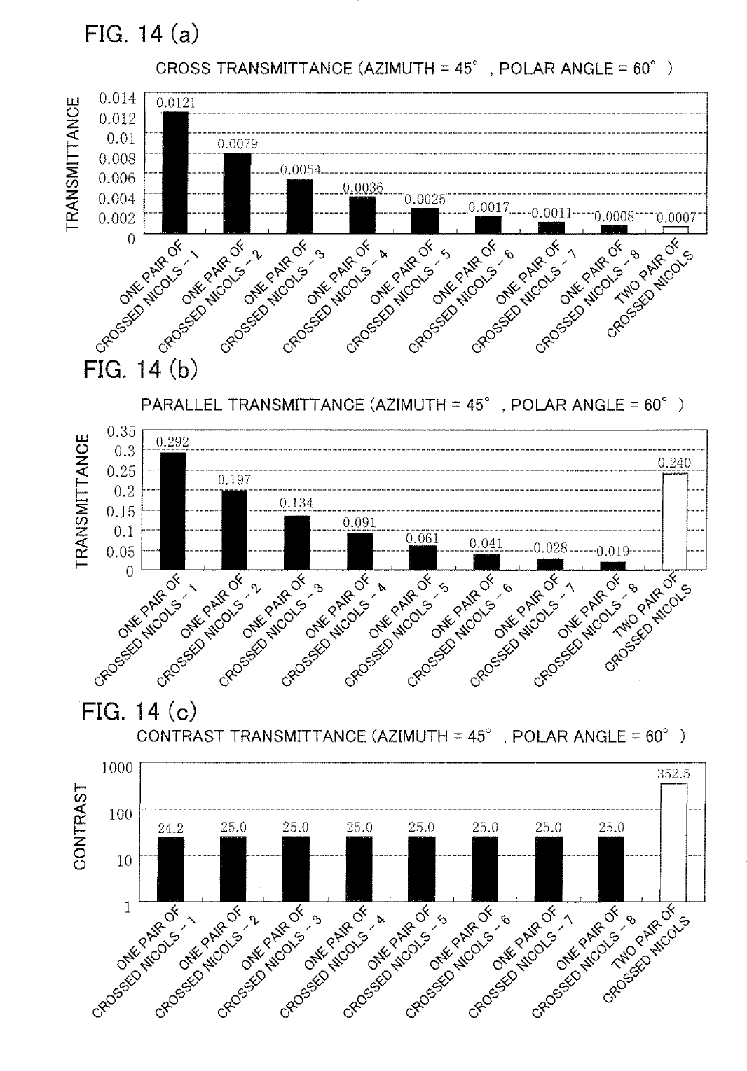

The following description deals with a thickness dependence of the polarization plate with reference to FIGS. 14(a) through 14(c). The thickness of a polarization plate is adjusted by combining (i) a pair of polarization plates which are provided to form crossed Nicols and (ii) polarization plates one by one each having the same polarization axis as the polarization plate to be combined, as shown in structure III of FIG. 10(c). FIG. 10(c) shows an example in which a pair of crossed Nicols polarization plates 101a and 101b and another polarization plates 101a and 101b having the same polarization axes, respectively, are combined. In this case, the polarization plates are arranged so that a pair of crossed Nicols polarization plates and additional two other polarization plates are included. For convenience, this kind of arrangement is hereinafter referred to as “one crossed pair—2.” Likewise, with each additional polarization plate, such arrangements are respectively referred to as “one crossed pair—3,” “one crossed pair—4,” and on. In the graphs in FIGS. 14(a) through 14(c), measurements are made on an assumption that an angle of direction is 45° and a polar angle is 60°.

FIG. 14(a) is a graph representing a relationship in black display between a thickness and transmittance (cross transmittance) of a pair of polarization plates provided to form crossed Nicols. FIG. 14(a) shows transmittance obtained in cases where two pairs of polarization plates are provided to form crossed Nicols for comparison.

FIG. 14(b) is a graph representing a relationship in white display between a thickness and transmittance (parallel transmittance) of a pair of polarization plates provided to form crossed Nicols. FIG. 14(b) shows transmittance obtained in cases where two pairs of polarization plates are provided to form crossed Nicols for comparison.

The graph in FIG. 14(a) demonstrates that the combining of polarization plates can reduce the transmittance in black display. Meanwhile, the graph in FIG. 14(b) demonstrates that the combining of polarization plates reduces the transmittance in white display. Simply the combining of the polarization plates for restraining the occurrence of deterioration in black crispness in black display causes a decrease in the transmittance in white display.

FIG. 14(c) is a graph representing a relationship between a thickness and the contrast of a pair of polarization plates that are provided to form crossed Nicols. The graph also shows contrast obtained in cases where two pairs of polarization plates are provided to form crossed Nicols for comparison.

As is clear from the graphs in FIGS. 14(a) through 14(c), an arrangement in which two pairs of polarization plates provided to form crossed Nicols (i) allows a deterioration in black crispness to be restrained in black display and (ii) allows avoidance that the transmittance is lowered in white display. Besides, since the arrangement including the two pairs of polarization plates provided to form crossed Nicols has three polarization plates in total, it is possible to greatly improve the contrast, without increasing the total thickness of the liquid crystal display.

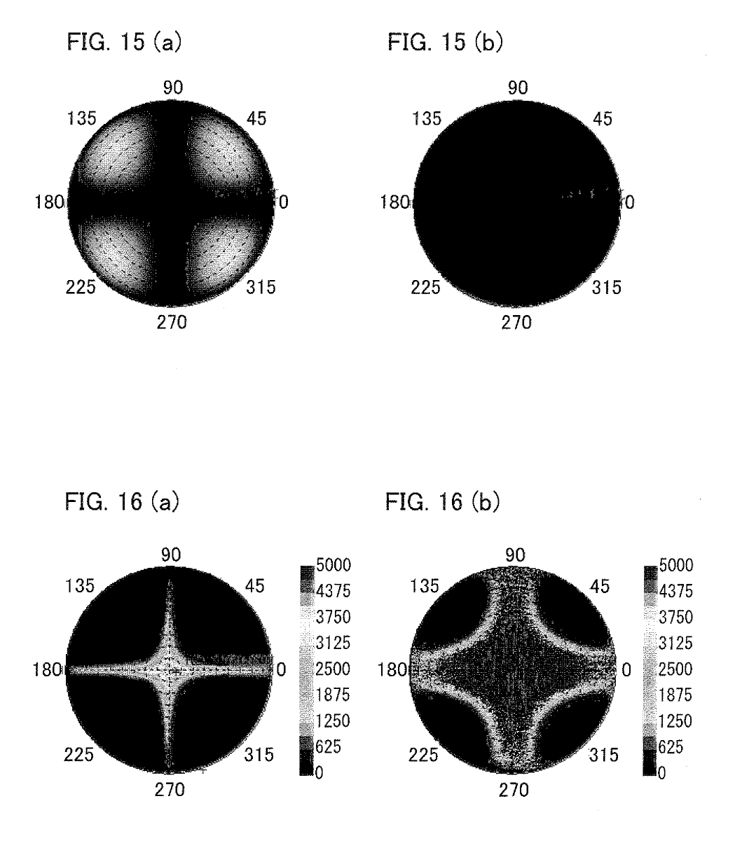

FIGS. 15(a) and 15(b) concretely illustrate viewing angle characteristics of crossed Nicol transmittance. FIG. 15(a) is a diagram illustrating the viewing angle characteristic of the crossed Nicols transmittance in structure I, that is, a two-polarization-plate structure in which a pair of polarization plates are provided to form crossed Nicols. FIG. 15(b) is a diagram illustrating the viewing angle characteristic of the crossed Nicols transmittance in structure II, that is, a three-polarization-plate structure in which two pairs of polarization plates are provided to form crossed Nicols.

FIGS. 15(a) and (b) demonstrate that the structure in which two pairs of polarization plates provided to form crossed Nicols is almost free from a deterioration in black crispness (such a deterioration corresponds to an increase in the transmittance in black display). This advantage is evident at 45°, 135°, 225°, and 315°.

FIGS. 16(a) and 16(b) concretely illustrate viewing angle characteristics of contrast (parallel/cross luminance). FIG. 16(a) is a diagram illustrating viewing angle characteristics of the contrast of structure I, that is, a two-polarization-plate structure in which a pair of polarization plates are provided to form crossed Nicols. FIG. 16(b) is a diagram illustrating the viewing angle characteristics of the contrast of structure II, that is, a three-polarization-plate structure with two pairs in which two pairs of polarization plates are provided to form crossed Nicols.

FIGS. 16(a) and 16(b) demonstrate that the contrast is more improved in the structure in which two pairs of polarization plates are provided to form crossed Nicols than in the structure in which a pair of polarization plates are provided to form crossed Nicols.

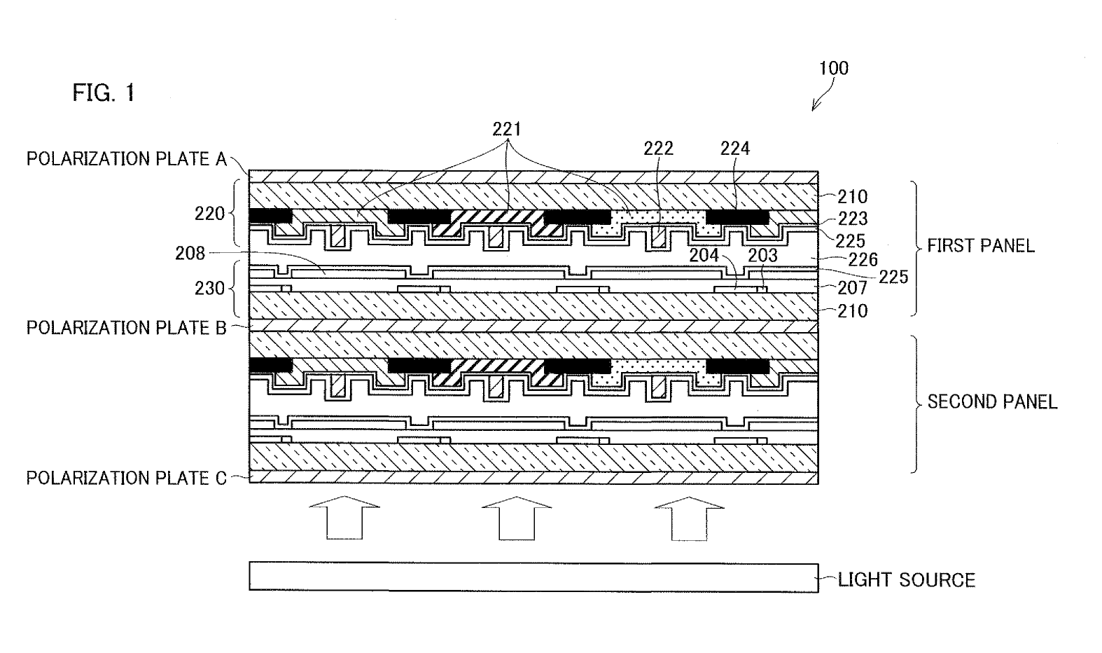

Now, referring to FIGS. 1 through 9, the following description deals with a liquid crystal display device which makes use of a principle for improving the contrast.

For simplification, the following description deals with a case where two liquid crystal panels are used.

FIG. 1 is a schematic cross section diagram of a liquid crystal display device 100 in accordance with the present embodiment.

The liquid crystal display device 100, including (i) a first panel and a second panel and (ii) polarizing plates A, B and C, is arranged such that the panels and the polarization plates are combined alternately as illustrated in FIG. 1.

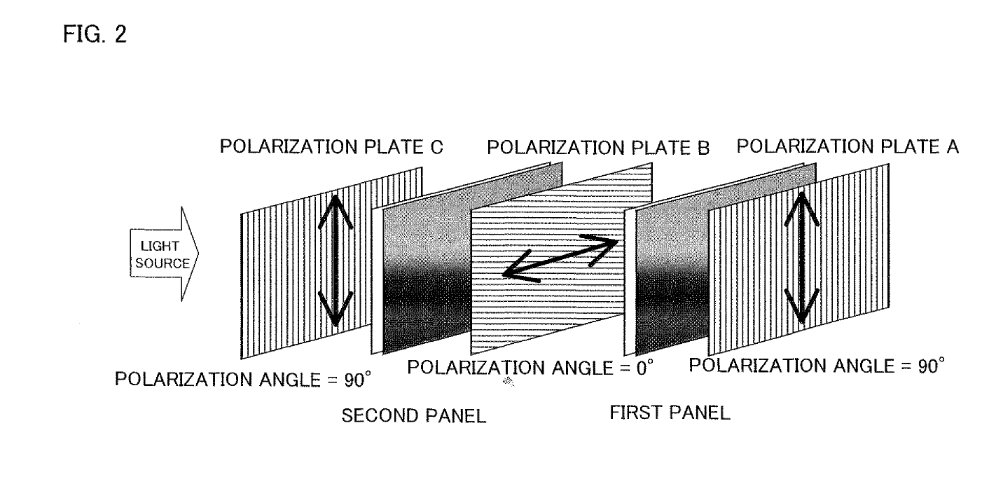

FIG. 2 is a drawing illustrating the arrangement of the polarization plates and the liquid crystal panels in the liquid crystal display device 100 illustrated in FIG. 1. In FIG. 2, the polarization plates A, B, and C are provided so that the polarization axis of the polarization plate B is perpendicular to those of the polarization plates A, C. Namely, the polarization plates A and B are provided to form crossed Nicols, and the polarization plates B and C are provided to form crossed Nicols.

Each of the first and second panels is arranged so that a liquid crystal is sealed between a pair of transparent substrates (a color filter substrate 220 and an active matrix substrate 230). Each of the panels includes means for arbitrarily switching states between (i) a state in which the polarized light incident on the polarization plate A from the light source is rotated by approximately 90°; (ii) a state in which the polarized light is not rotated; and (iii) an intermediate state between the states (i) and (ii). The switching is performed by electrically changing the alignment of the liquid crystal.

The first and second panels each include a color filter and are capable of displaying an image using a plurality of pixels. This display function is achieved by some display types: TN (Twisted Nematic) type, VA (Vertical Alignment) type, IPS (In Plain Switching) type, FFS (Fringe Field Switching) type, and combinations of these types. Among these types, VA is suitable since the type alone exhibits high contrast. Although the description here will focus on MVA (Multidomain Vertical Alignment) type, IPS and FFS types are also sufficiently effective because both operate in normally black type. The liquid crystal is driven by an active matrix driving using TFTs (Thin Film Transistors). As to a detailed description of MVA manufacturing methods, see Japanese Unexamined Patent Publication, Tokukaihei, No. 2001-83523, for example.

The first and second panels in the liquid crystal display device 100 have the same structure. Each of the panels includes the color filter substrate 220 and the active matrix substrate 230 provided face to face as aforementioned, and is arranged so that spacers (not illustrated) are provided between the two substrates to maintain a constant distance between the two substrates. The spacers are, for example, plastic beads or resin columns erected on the color filter substrate 220. Liquid crystal is sealed between the pair of substrates (the color filter substrate 220 and the active matrix substrate 230). A perpendicular alignment film 225 is formed on the surface of each of the substrates which surface comes in contact with the liquid crystal. The liquid crystal is a nematic liquid crystal with negative dielectric anisotropy.

The color filter substrate 220 includes a transparent substrate 210. Color filters 221, black matrixes 224, and other components are provided above the transparent substrate 210. The color filter substrate 220 is also provided with alignment controlling projections 222 which specifies the alignment direction of the liquid crystal.

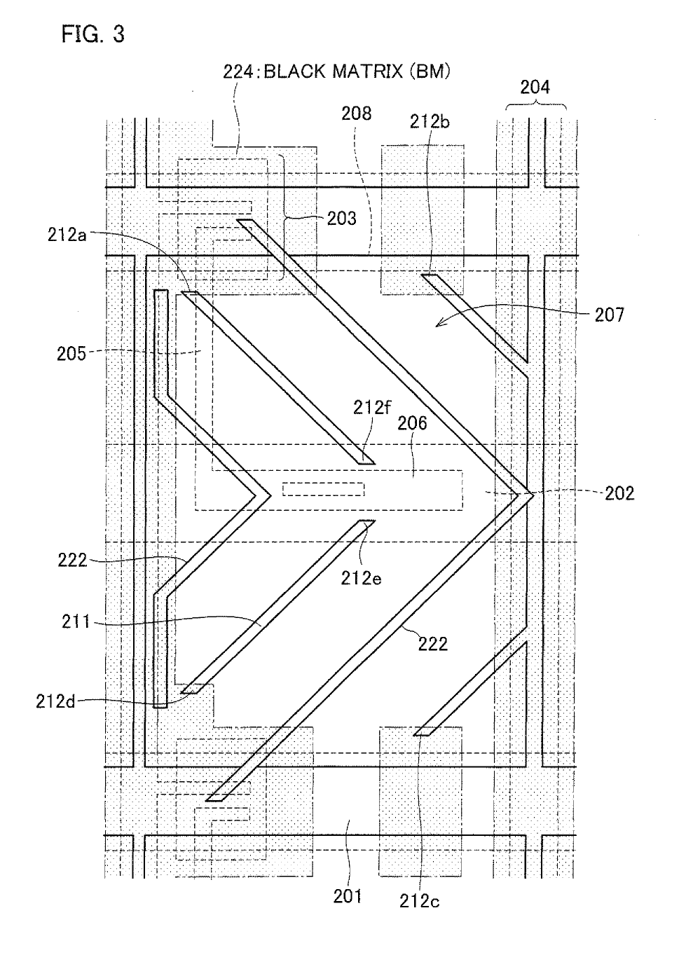

The active matrix substrate 230 includes the transparent substrate 210, as illustrated in FIG. 3. TFT elements 203, pixel electrodes 208, and other components are provided on the transparent substrate 210. The active matrix substrate 230 is provided also with alignment control slit patterns 211 which specify an alignment direction of the liquid crystal. When projecting a pattern formed on the color filter substrate 220 onto the active matrix substrate 230, the alignment controlling projections 222 and the black matrix 224 are illustrated as in FIG. 3. The black matrix 224 is provided for blocking unnecessary light which causes a deterioration in display quality. When a voltage of not less than a threshold voltage is applied to a pixel electrode 208, liquid crystal molecules is inclined perpendicular to the projections 222 and the slit patterns 211. In the present embodiment, the projections 222 and the slit patterns 211 are formed so that the liquid crystal aligns at an angle of direction of 45° with respect to the polarization axis of the polarization plate.

As described in the foregoing, the first and second panels are arranged so that red (R), green (G), and blue (B) pixels of each of the color filters 221 of the first panel correspond to those of a respective color filter 221 of the second panel when they are viewed in a vertical direction. Specifically, the R pixel of a color filter 221 of the first panel corresponds to that of a respective color filter 221 of the second panel; the G pixel of a color filter 221 of the first panel corresponds to that of a respective color filter 221 of the second panel; and the B pixels of a color filter 221 of the first panel corresponds to that of a respective color filter of the second panel, each when they are viewed in a vertical direction.

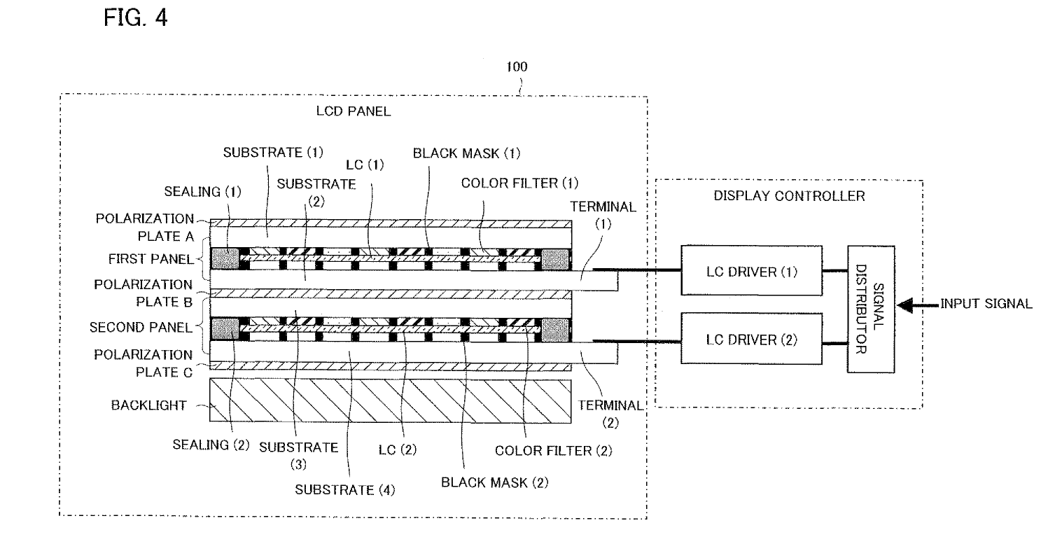

FIG. 4 is a schematic drawing illustrating a drive system for the liquid crystal display device 100 having the arrangement.

The drive system includes a display controller required to display video on the liquid crystal display device 100.

As a result, the liquid crystal panel outputs a suitable image corresponding to an input signal.

The display controller includes a first panel drive circuit (1) and a second panel drive circuit (2) which drive the first and the second panel in accordance with predetermined signals, respectively. The display controller also includes a signal distribution circuit section which distributes a video source signal to the first panel drive circuit (1) and the second panel drive circuit (2).

Note that the input signal includes not only a video signal from a TV receiver, a VTR, or a DVD player, but also a signal obtained by processing the video signal.

Therefore, the display controller sends signals to each of the panels so that the liquid crystal display device 100 can suitably display an image.

The display controller is provided for sending suitable electric signals to the panels based on a supplied video signal, and includes drivers, circuit boards, panel drive circuits, and other components.

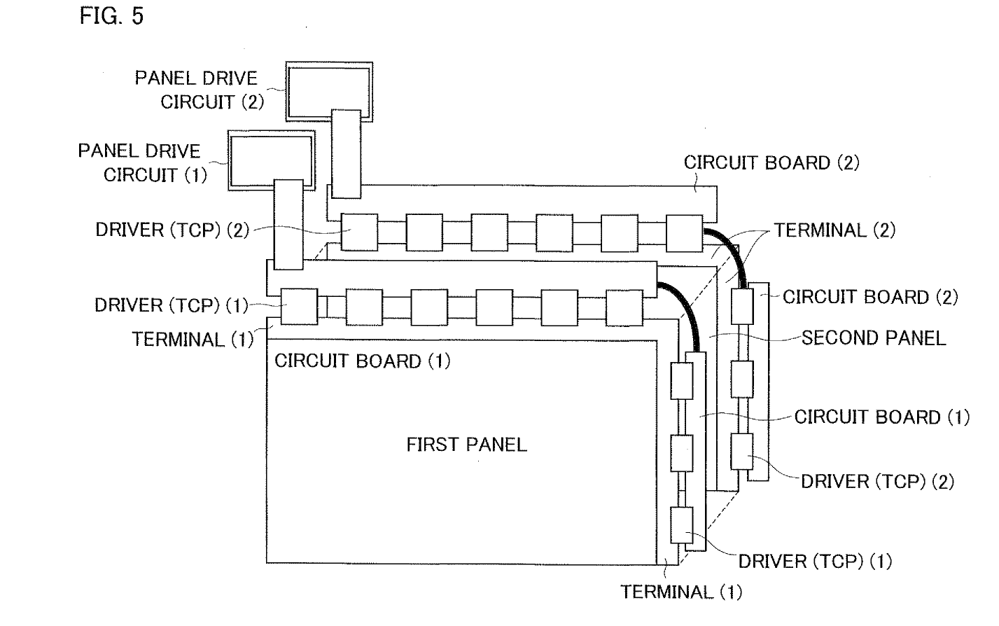

FIG. 5 illustrates how the first and second panels are connected to their panel drive circuits, respectively. Note that the polarization plates are omitted in FIG. 5.

The first panel drive circuit (1) is connected via drivers (TCP) (1) to a terminal (1) provided on a circuit board (1) of the first panel. In other words, the first panel is connected to the drivers (TCP) (1), the drivers TCP (1) are connected to the circuit board (1), which is connected to the panel drive circuit (1).

The second panel drive circuit (2) is connected to the second panel in the same manner as the first panel drive circuit (1) is connected to the first panel; no further description is given.

The following description deals with an operation of the liquid crystal display device 100 having the arrangement.

A pixel in the first panel is driven in accordance with a display signal. A respective pixel in the second panel, which pixel corresponds to that in the first panel when these pixels are viewed in a vertical direction, is driven in association with the first panel. When a section (constitutive section 1) constituted by the polarization plate A, the first panel, and the polarization plate B is in a transmitting state, so does a section (constitutive section 2) constituted by the polarization plate B, the second panel, and the polarization plate C. When constitutive section 1 is in a non-transmitting state, nor does the constitutive section 2.

The first and second panels may receive identical image signals. Instead, the first and second panels may receive associated but different signals.

The following description deals with a manufacturing method for the active matrix substrate 230 and the color filter substrate 220.

The manufacturing method for the active matrix substrate 230 will be first described.

A metal film, such as a Ti/Al/Ti film stack, is formed on a transparent substrate 10 by sputtering so that scan signal wiring (gate wiring, gate lines, gate voltage lines, or gate bus lines) 201 and auxiliary capacitor wiring 202 are formed as illustrated in FIG. 3. Thereafter, a resist pattern is formed on the films by the photolithography method, and then a dry-etching is carried out by using an etching gas such as chlorine-based gas to remove the resist. This simultaneously forms the scan signal wiring 201 and the auxiliary capacitor wiring 202 on the transparent substrate 210.

Thereafter, a gate insulating film, an active semiconductor layer, and a low resistance semiconductor layer are formed, all by CVD. The gate insulating film is made of a silicon nitride (SiNx) or other material, the active semiconductor layer is made of amorphous silicon or other material, and the low resistance semiconductor layer is made of amorphous silicon or other material doped with, for example, phosphor. Then, in order to form data signal wiring (source wires, source lines, source voltage lines, or source bus lines) 204, drain lead-out wiring 205, and auxiliary capacitor forming electrodes 206, a metal film such as Al/Ti film are formed by sputtering. Thereafter, a resist pattern is formed on the films by the photolithography method, and then a dry-etching is carried out by using an etching gas such as chlorine-based gas to remove the resist. This simultaneously forms the data signal wiring 204, the drain lead-out wiring 205, and the auxiliary capacitor forming electrodes 206.

An auxiliary capacitor is formed by an arrangement in which a gate insulating film having a thickness of about 4000 angstrom is sandwiched between auxiliary capacitor wiring 202 and an auxiliary capacitor forming electrode 206.

Thereafter, the low resistance semiconductor layer is dry-etched by using for example a chlorine gas to separate a source from a drain. This results in that a TFT element 203 is formed.

Next, an interlayer insulating film 207 is formed by spin coating. The interlayer insulating film 207 is made of an acrylic photosensitive resin or other material. Contact holes (not illustrated) which electrically connect the drain lead-out wiring 205 to the pixel electrodes 208 are formed by the photolithography method. The interlayer insulating film 207 has a thickness of about 3 μm.

Furthermore, pixel electrodes 208 and a perpendicular alignment film (not illustrated) are formed in this order.

The present embodiment deals with an MVA liquid crystal display device as mentioned earlier and includes a slit pattern 211 in the pixel electrodes 208. The pixel electrodes 208 are made of ITO or other material. Specifically, a film is formed by sputtering, and then a resist pattern is formed by the photolithography method. Etching is then carried out by using an etching solution, such as iron chloride. This results in that a pixel electrode pattern is obtained as illustrated in FIG. 3.

The above process allows an active matrix substrate 230 to be manufactured.

The reference numerals 212a, 212b, 212c, 212d, 212e, and 212f in FIG. 3 indicate electrical connection sections of the slit in the pixel electrode 8. In the electrical connection sections of the slit, alignment is disturbed, resulting in alignment abnormality. In addition to the alignment abnormality, the following problem arises. A positive electric potential, is applied to the gate wiring to turn on the TFT element 203 generally for a period of microseconds, whereas a negative electric potential, is applied to turn off the TFT element 203 generally for a period of milliseconds. Thus, a negative electric potential, is predominantly applied to the TFT element 203. As such, if the slits 212a through 212d are disposed on the gate wiring, a negative gate DC component applied to the gate causes impurity ion contained in the liquid crystal to gather together. This is likely to be perceived as nonuniform display. On this account, it is necessary that the slits 212a through 212d be disposed so that the gate wiring and the slits 212a through 212d do not overlap. Thus, it is desirable that the slits 212a through 212d be masked with the black matrix 224 as illustrated in FIG. 3.

The following description deals with a manufacturing method for the color filter substrate 220.

The color filter substrate 220 includes the transparent substrate 210. A color filter layer, a counter electrode 223, a perpendicular alignment film 225, and alignment controlling projections 222 are provided on the transparent substrate 210. The color filter layer includes the color filters 221 of the three primary colors [red, green, and blue) and the black matrix (BM) 224.

After the transparent substrate 210 is coated, by spin coating, with an acrylic photosensitive resin solution of negative-type in which fine carbon particles are dispersed, and is then dried, thereby to form a black photosensitive resin layer. Subsequently, the black photosensitive resin layer is exposed via a photomask and is then developed, thereby to form a black matrix (BM) 224. The BM is formed so as to have an opening for a first colored layer (e.g. red layer), an opening for a second colored layer (e.g. green layer), and an opening for a third colored layer (e.g. blue layer) in areas where the first, second, and third colored layers will be provided, respectively. The openings correspond to the pixel electrodes, respectively. More specifically, as illustrated in FIG. 3, an island shaped BM pattern is formed, and a light blocking section (BM) is formed on the TFT elements 203. The BM pattern carries out light shielding with respect to regions, in the slits 212a to 212d (corresponding to the electrical connection sections of the slits 212a to 212f formed in the pixel electrodes 208), where the alignment abnormality occurs. The light blocking section (BM) prevents an increase in leak current due to photoexcitation made by external light incident on the TFT elements 203.

After the application of an acrylic photosensitive resin solution of negative-type in which a pigment is dispersed by spin coating, drying process is carried out. Then, an exposure and a development are carried out with the use of a photomask, thereby to form a red layer.

Similarly, the second colored layer (e.g. green layer) and the third colored layer (e.g. blue layer) are formed. That completes the manufacture of the color filters 221.

Furthermore, a counter electrode 223 made of a transparent electrode such as ITO is formed, by sputtering. The counter electrode 223 is coated with a phenol novolac photosensitive resin solution of positive-type by spin coating, is dried, and is subjected to exposure and development with the use of a photomask, thereby to form a perpendicular alignment controlling projection 222. Then, columnar spacers (not illustrated) are formed to specify a cell gap for the liquid crystal panel, by carrying out (i) an exposure with the use of a photomask, (ii) an development, and (iii) a hardening with respect to applied acrylic photosensitive resin solution. The resin solution is exposed to light using a photo mask, developed and cured.

Thus a color filter substrate 220 is formed.

The present embodiment deals with a BM made of resin but may be made of metal instead. The colored layers of the three primary colors are not limited to red, green, and blue. Instead, they may be cyan, magenta, and yellow, and alternatively, they may further include a white layer.

The following description deals with how to manufacture a liquid crystal panel (first and second panels) with the use of a color filter substrate 220 and an active matrix substrate 230.

First, a perpendicular alignment film 225 is formed on each surface of the color filter substrate 220 and the active matrix substrate 230, which surface comes in contact with a liquid crystal. Specifically, each of the substrates 220 and 230 is baked for degassing, is cleaned, and then an alignment film is applied. Thereafter, the alignment film is baked. After the cleaning of the applied alignment film, a further baking is carried out for degassing. The perpendicular alignment film 225 specifies an alignment direction of the liquid crystal 226.

The following description deals with how to seal a liquid crystal between the active matrix substrate 230 and the color filter substrate 220.

A liquid crystal may be sealed by a method such as a vacuum filling method. According to the vacuum filling method, the following steps are processed. A thermosetting sealing resin is applied on the periphery of the substrate while securing an injection hole for injecting the liquid crystal. The injection hole is immersed in the liquid crystal in vacuum, and is then vented to atmosphere so that the injection of the liquid crystal can be made. Finally, the injection hole is sealed by, for example, a UV cure resin. Note however that it takes much longer to inject the liquid crystal in a liquid crystal panel having perpendicular alignment than in a liquid crystal panel having parallel alignment. Therefore, a drop liquid crystal bonding method is employed here.

A UV cure sealing resin is applied to the periphery of an active matrix substrate, and a liquid crystal is dropped onto a color filter substrate by the dropping method. With the use of the drop liquid crystal method, an optimal amount of liquid crystal is dropped regularly inside the sealing so that the liquid crystal secures a desired cell gap.

The pressure inside a combining device is reduced to 1 Pa so that (i) the color filter substrate that has been subjected to the sealing plot and the drop liquid crystal and (ii) the active matrix substrate are combined. After the two substrates are combined under the depressurized state, the pressure is changed back to the atmospheric pressure, so that the seal part is collapsed. This allows a desired gap in the seal part.

The resultant structure with a desired cell gap in the seal part is irradiated with UV radiation by a UV cure device, thereby carrying out a provisional curing of the sealing resin. The structure is then baked so that the sealing resin is finally cured. At this stage, the liquid crystal moves into every corner inside the sealing resin, thereby resulting in that the liquid crystal is fully filled in the cell. Following the completion of the baking, the structure is divided into individual liquid crystal panels. Thus, a liquid crystal panel is completed.

In the present embodiment, the first and second panels are manufactured in the same process.

The following description deals with how to mount first and second panels manufactured by the manufacturing method.

Here, the first and second panels are cleaned, and a polarization plate is combined with each of the panels. Specifically, polarization plates A and B are combined with a front surface and a back surface of the first panel, respectively, as illustrated in FIG. 4. A polarization plate C is attached to a back surface of the second panel. Another layer such as an optical compensation sheet is further provided on each of the polarization plates, where necessary.

Following this, drivers (liquid crystal driver LSI) are connected. Here, the drivers are connected using a TCP (Tape Career Package) method.

For example, an ACF (Anisotropic Conductive Film) is attached to the terminals (1) of the first panel by provisional compression as illustrated in FIG. 5. Thereafter, the TCPs (1) on which the drivers are mounted are punched out of the carrier tape, aligned with a panel terminal electrode, and heated for complete compression/attachment. Thereafter, the input terminals (1) of the TCPs (1) are connected to the circuit board (1) using the ACF. The circuit board (1) is provided to couple the driver TCPs (1) together.

Next, the two panels are combined. The polarization plate B has an adhesive layer on each surface thereof. The surface of the second panel is cleaned, and the laminates of the adhesive layers of the polarizer B on the first panel are peeled off. The first and second panels are precisely aligned, and then combined. Bubbles may be trapped between the panel and the adhesive layer during the combining process. It is therefore desirable to combine the panels in vacuum.

The panels may be combined by an alternative method as follows. An adhesive agent such as an epoxy adhesive agent is applied to the periphery of the panels. This adhesive agent is one which cures at normal temperatures or at a temperature not exceeding the panel's thermal resistance temperature. Plastic spacers are scattered, and, for example, fluorine oil is sealed. Preferred materials are optically isotropic liquids with a refractive index substantially equal to that of a glass substrate and with stability substantially equal to the liquid crystal.

The present embodiment is applicable to cases where the terminal surfaces of the first and second panels are at the same position as illustrated in FIGS. 4 and 5. The terminals may be disposed in any direction with respect to the panel and attached to the panel by any method. For example, they may be fixed mechanically instead of using adhesive.

To reduce the parallax caused by the thickness of the internal glass, the two panels preferably have their inner substrates face each other and have a thickness as thin as possible.

In this regard, when glass substrates are used, thin substrates are straightly available. Feasible substrate thicknesses may vary from one manufacturing line to another and depending on the dimensions of the liquid crystal panels and other conditions. For example, it is possible to adopt glass having a thickness of 0.4 mm as the inner substrate.

Alternatively, the glass may be polished or etched. Glass can be etched by publicly known techniques (see, for example, Japanese Patents No. 3524540 and No. 3523239). For example, a chemical treatment solution such as a 15% aqueous solution of hydrofluoric acid is used. Any parts, such as the terminal surface, which should not be etched, are coated with an acid-proof protective material. The glass is then immersed in the chemical treatment solution for etching. Following the etching, the protective material is removed. The etching reduces the thickness of the glass to about 0.1 mm to 0.4 mm. After combining the two panels, they are integral with a lighting system referred to as a backlight. This realizes a liquid crystal display device 100.

Now, the following description deals with concrete examples of a lighting system suitable to the present invention. The present invention is however not limited to the arrangement of the lighting system discussed below; any changes may be made where necessary.

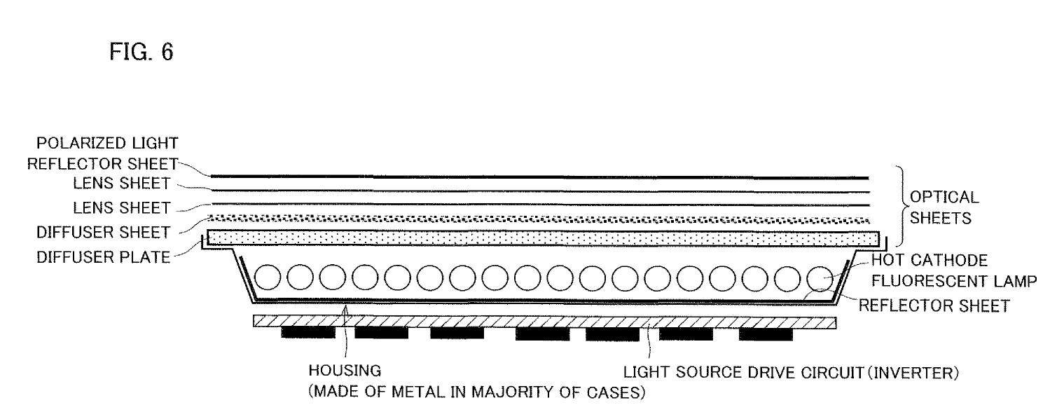

The liquid crystal display device 100 of the present invention, due to its display principle, needs a more powerful backlight than conventional panels. In addition, the absorption for short wavelengths becomes more remarkable. As such, it is necessary that the lighting system adopt a blue light source whose wavelengths are shorter. FIG. 6 illustrates an example of a lighting system which meets these conditions.

Hot cathode fluorescent lamps are used for the liquid crystal display device 100 of the present invention to obtain luminance similar to conventional ones. The hot cathode fluorescent lamp has a feature that it can output about 6 times as much amount of light as a cold cathode fluorescent lamp used under general specifications.

When taking a 37-inch WXGA display as an example of a standard liquid crystal display device, 18 lamps are provided on an aluminum housing. Each of the 18 lamps has an external diameter φ of 15 mm. The housing includes a white reflecting sheet made of foaming resin for efficient usage of the light emitted backward from the lamps. The power source for the lamps is provided on the back surface of the housing, and receives the commercial power to drive the lamps.

Next, it is necessary that a translucent white resin plate be provided to eliminate images of the lamps in a direct backlighting realized by disposing a plurality of lamps in the housing. In the present example, a plate member, having a thickness of 2 mm, which is made primarily of polycarbonate and exhibits high resistance to wet warping and heat deformation is disposed on the housing for the lamps. Provided on top of the plate member are optical sheets and other sheets, i.e., a diffusing sheet, two lens sheets, and a polarized light reflecting sheet in the order of closing to the top of the plate member. This achieves predetermined optical effects. With these specifications, it is possible that the backlight is about 10 times as bright as typical conventional specifications in which 18 cold cathode fluorescent lamps having an external diameter φ of 4 mm, two diffusing sheets, and a polarized light reflecting sheet are used. The 37-inch liquid crystal display device of the present invention is hence capable of attaining about 400 cd/m² luminance.

Note however that the backlight dissipates 5 times as much heat as a conventional backlight. In view of this, there are provided on the back surface of a back chassis (i) a fan urging the heat to be dissipated to air and (ii) a fan forcing air flow to be created.

The mechanical members of the lighting system double as main mechanical members for a whole liquid crystal module. The packaged panels are disposed in the backlight. A liquid crystal display controller including panel drive circuits and signal distributors, a power source for light source, and in some cases a commercial power source are further provided, thereby to complete a liquid crystal module. The packaged panels are disposed in the backlight, and a frame body is disposed to hold the panels together, thereby to complete a liquid crystal display device of the present invention.

The present embodiment deals with a direct backlighting system using a hot cathode fluorescent lamp. Alternatively, the lighting system, as usage, may be of a projection type or an edge light type. The light source may be cold cathode fluorescent lamps, LEDs, OELs, or electron beam fluorescence tubes. Any optical sheets may be selected for a suitable combination.

The embodiment above deals with the case where the slits are provided in the pixel electrodes of the active matrix substrate, and the alignment controlling projections are provided on the color filter substrate, so as to control the alignment direction of the perpendicular alignment liquid crystal molecules. As another embodiment, the slits and the projections may be transposed. Alternatively, slits may be provided in the electrodes of both substrates. An MVA liquid crystal panel may be used which has alignment controlling projections on the surfaces of the electrodes of both of the substrates.

Besides the MVA type, a pair of perpendicular alignment films may be used which specify orthogonal pre-tilt directions (alignment treatment directions). Alternatively, VA mode in which liquid crystal molecules are in twist alignment may be used. VATN type, mentioned earlier, may also be used. The VATN type is preferable in the present invention since contrast is not reduced by the light leaked from the part where the alignment controlling projections are provided. The pre-tilt is formed by, for example, an optical alignment.

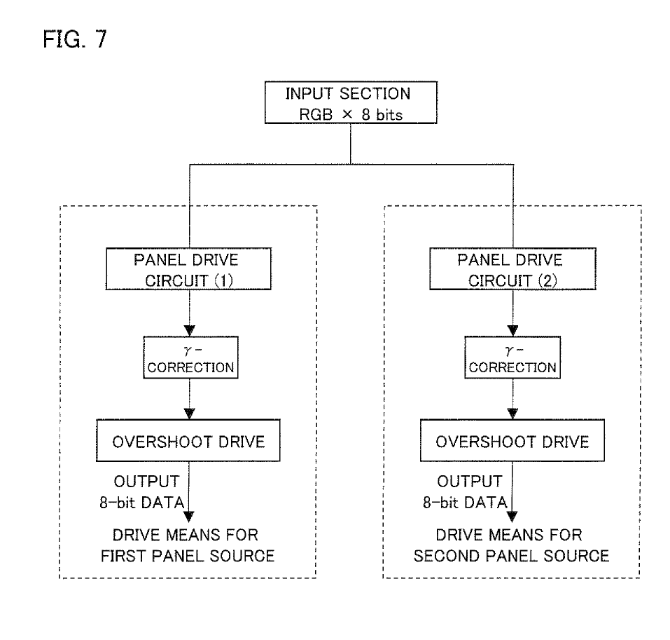

Referring to FIG. 7, the following description deals with a concrete example of a driving method implemented by the display controller of the liquid crystal display device 100 having the arrangement. Note that the following description deals with a case of 8-bit (256 gray levels) inputs and 8-bit liquid crystal drivers.

The panel drive circuit (1) in the display controller section performs γ-correction, overshooting, and other drive signal processing with respect to an input signal (video source) to output 8-bit gray level data to a source driver (source drive means) of the first panel.

Meanwhile, the panel drive circuit (2) performs γ-correction, overshooting, and other signal processing to output 8-bit gray level data to a source driver (source drive means) of the second panel.

Both the first and second panels handle 8-bit data. Output images of 8-bit are outputted from the first and second panels, respectively. The output images and the input signal have a one-to-one relationship. An input signal is faithfully reproduced.

As mentioned in the foregoing, moire markedly occurs when the first and second panels are combined. This is caused by a pixel displacement which occurs in two pixels when the two panels are combined. Generally, it is extremely difficult to combine two panels without such a pixel displacement. As such, it is very difficult to combine two panels with completely no pixel displacement. Besides, the thickness of glass and other components may cause the parallax, thereby causing another moire to occur.

The following embodiment of the present invention deals with how to address the moire caused by the combination of two panels.

### FIRST EMBODIMENT

The present embodiment deals with a reduction in the occurrence of moire when two or more liquid crystal panels are combined, by using a transparent conductive film as the signal wiring of liquid crystal panels which constitute a liquid crystal display device 100. The signal wiring includes scanning signal lines, auxiliary capacitor wiring, and data signal lines.

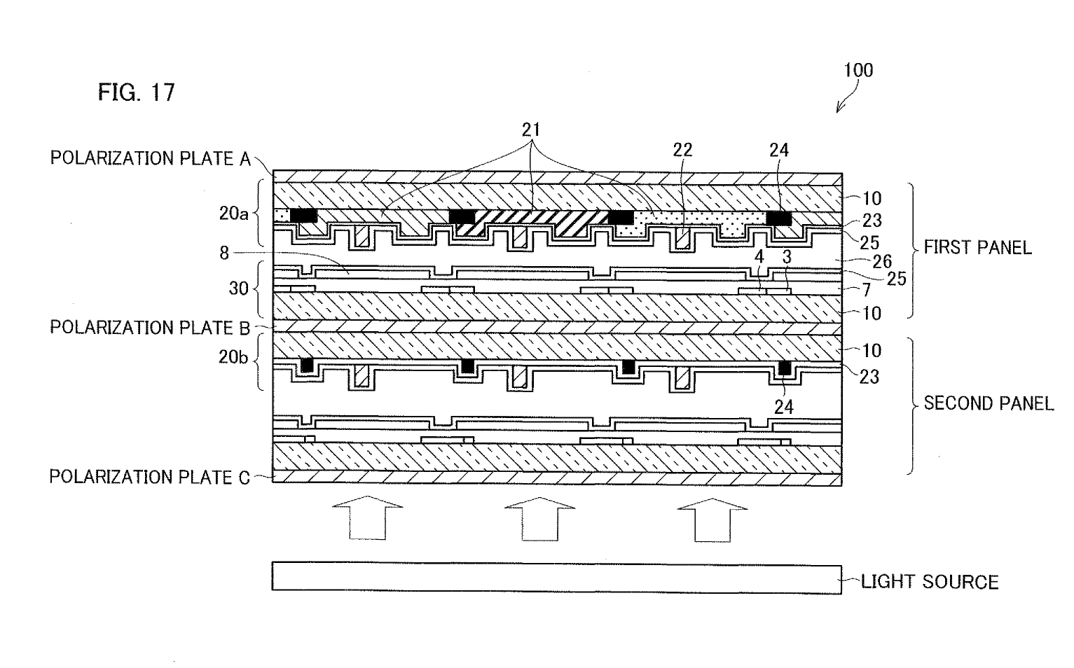

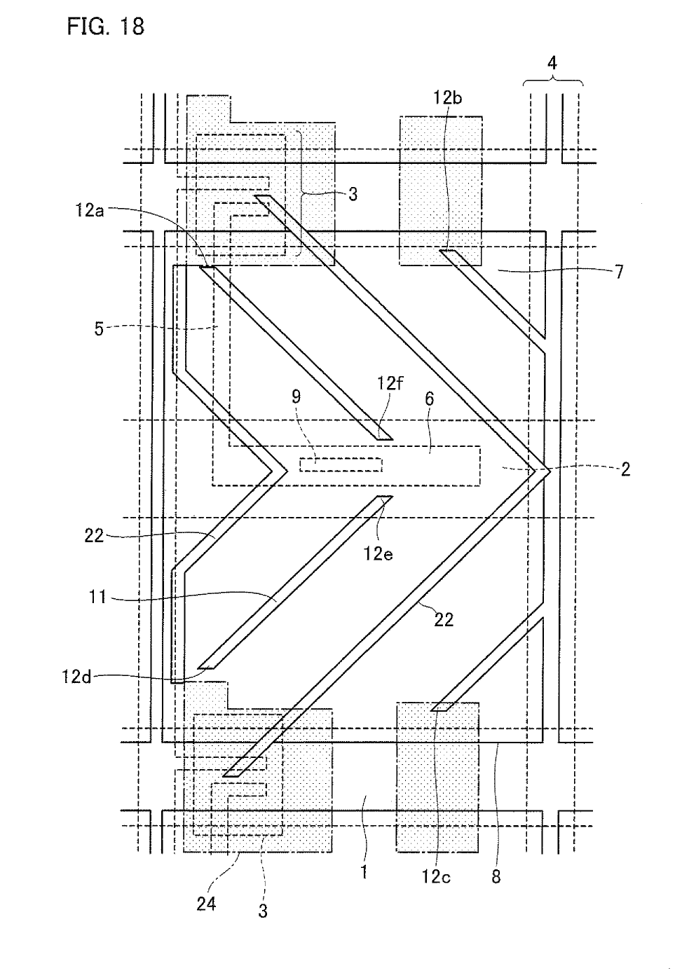

The following description deals with the liquid crystal display device 100 in accordance with the present embodiment, with reference to FIGS. 17 and 18. FIG. 17 is a cross sectional view illustrating the liquid crystal display device 100. FIG. 18 is a plan view illustrating the vicinity of a pixel electrode in the liquid crystal display device 100 illustrated in FIG. 17.

The arrangement of polarization plates in the liquid crystal display device 100 illustrated in FIG. 17 is the same as that illustrated in FIG. 2.

FIG. 18 is a plan view illustrating one pixel in the first and second panels of the liquid crystal display device 100 illustrated in FIG. 17. FIG. 18 is drawn so that an island shaped BM 24b (black matrix) is on the side of a counter substrate 20b and an alignment controlling projections 22 overlap on the active matrix substrate.

In the embodiment, each of the signal wiring is made of transparent conductive film, which signal wiring is provided on the active matrix substrate of the first and second panels.

A pixel in the first panel is driven in response to a display signal. A respective pixel in the second panel, which pixel is disposed to coincide with the pixel in the first panel when viewed in a direction vertical to the panels, is driven in association with the first panel. When a section constituted by a polarization plate A, the first panel, and a polarization plate B (constitutive section 1) is in a transmitting state, so does a section constituted by the polarization plate B, the second panel, and a polarization plate C (constitutive section 2). When constitutive section 1 is in a non-transmitting state, nor does the constitutive section 2.

The first and second panels may receive identical image signals. Instead, the first and second panels may receive associated but different signals. The pixels of the first and second panels are arranged so that a pixel in the second panel is disposed to coincide with a respective pixel in the first panel when viewed in a direction vertical to the panels.

The following description deals with how to manufacture the liquid crystal display device 100.

A manufacturing method for the active matrix substrate of the first and second panels is first described.

A transparent conductive film, which is made of a material such as an ITO (indium oxide containing Sn) and which has a thickness of 2 μm to 4 μm, is formed on a transparent substrate 10 by sputtering to form scan signal wiring (gate wiring or gate bus lines) 1 and auxiliary capacitor wiring 2 as illustrated in FIG. 18. A resist pattern is formed on the film by a photolithography method, and the films are etched by using a mixed solution of ferric chloride and hydrochloric acid to remove the resist. This simultaneously forms the scan signal wiring 1 and the auxiliary capacitor wiring 2 on the transparent substrate 10.

Thereafter, a gate insulating film, an active semiconductor layer, and a low resistance semiconductor layer are formed, all by CVD. The gate insulating film is made of a silicon nitride (SiNx) or other material, the active semiconductor layer is made of amorphous silicon or other material, and the low resistance semiconductor layer is made of amorphous silicon or other material doped with, for example, phosphor. Metal film which is made of a material such as an ITO and which has a thickness of 2 μm to 4 μm is formed by sputtering so that data signal wiring (source wiring or source bus lines) 4, drain lead-out wiring 5, and auxiliary capacitor forming electrodes 6 are formed. A resist pattern is formed on the metal film by the photolithography method, and the metal film is etched in a mixed solution of ferric chloride and hydrochloric acid to remove the resist. This simultaneously forms the data signal wiring 4, the drain lead-out wiring 5, and the auxiliary capacitor forming electrodes 6.

An auxiliary capacitor is formed by the auxiliary capacitor wiring 2, the auxiliary capacitor forming electrode 6 and a gate insulating film of about 4000 angstrom sandwiched therebetween.

Thereafter, the low resistance semiconductor layer is dry-etched, for example, in a chlorine gas to separate a source from a drain, thereby forming a TFT element 3.

Next, an interlayer insulating film 7 made of a material such as an acrylic photosensitive resin is applied and formed by a spin coating. A contact hole 9 which electrically connect the drain lead-out line 5 to the pixel electrode 8 is formed by the photolithography method. The interlayer insulating film 7 is approximately 3 μm thick.

Furthermore, a pixel electrode 8 and a perpendicular alignment film (not illustrated) are formed in this order to complete the manufacture.

The present embodiment is an MVA liquid crystal display device as mentioned earlier and includes a slit pattern 11 in the pixel electrodes 8 made of an ITO or other material. Specifically, a film is formed by sputtering, a resist pattern is formed by the photolithography method, and then, etching is carried out by an etching solution such as a mixed solution of ferric chloride and hydrochloric acid, thereby to form a pixel electrode pattern as illustrated in FIG. 18.

Thus an active matrix substrate 30 is obtained.

The present embodiment used, as a developer, an aqueous solution has a TMAH (tetramethyl ammonium hydroxide) density of 10 or less, and used, as a removing solution, a mixed solution of MEA (monoethanolamine) and DMSO (dimethylsulfoxide). The MEA and MSO are mixed in the ratio MEA:DMSO=2:1 to 3:1.

The ITO is used as the signal lines (scan signal lines, auxiliary capacitor wiring, data signal lines) in the present embodiment. However, a transparent conductive film such as IZO (indium oxide containing Zn) or ZnO (zinc oxide) may be used as the signal lines.

A manufacturing method for a color filter substrate 20a of the first panel is substantially the same as that for the color filter in the basic arrangement of the liquid crystal display device 100, except that the light blocking section (BM) is formed in an island form. As such, further detailed description of the manufacturing method is omitted.

In view of the circumstances, the present embodiment focuses mainly on a manufacturing method of a counter substrate 20b of the second panel.

An island black matrix (BM) 24b, a counter electrode 23, an alignment film 25 and alignment controlling projections 22 are formed on the transparent substrate 10.

First, an acrylic photosensitive resin solution of negative-type in which fine carbon particles are dispersed is applied onto the transparent substrate 10 by the spin coating, and is dried to form a black photosensitive resin layer. More specifically, as illustrated in FIG. 18, an island BM pattern is formed, and a light blocking section (BM) is formed on the TFT elements 3. The BM pattern carries out light shielding with respect to regions, in the slits 12a through 12d (corresponding to the electrical connection sections in the pixel electrode slits (MVA slits)), where the alignment abnormality occurs. The light blocking section (BM) is formed for preventing an increase in leak current due to photoexcitation made by external light incident on the TFT element 3.

Following the sputtering of a counter electrode 23 made of transparent electrode such as an ITO, a phenol novolac photosensitive resin solution of positive-type is applied by the spin coating, and is then dried. Thereafter, (i) an exposure and (ii) a development are carried out by using a photomask, thereby to form a perpendicular alignment controlling projection 22. Thus, a counter substrate 20b is formed.

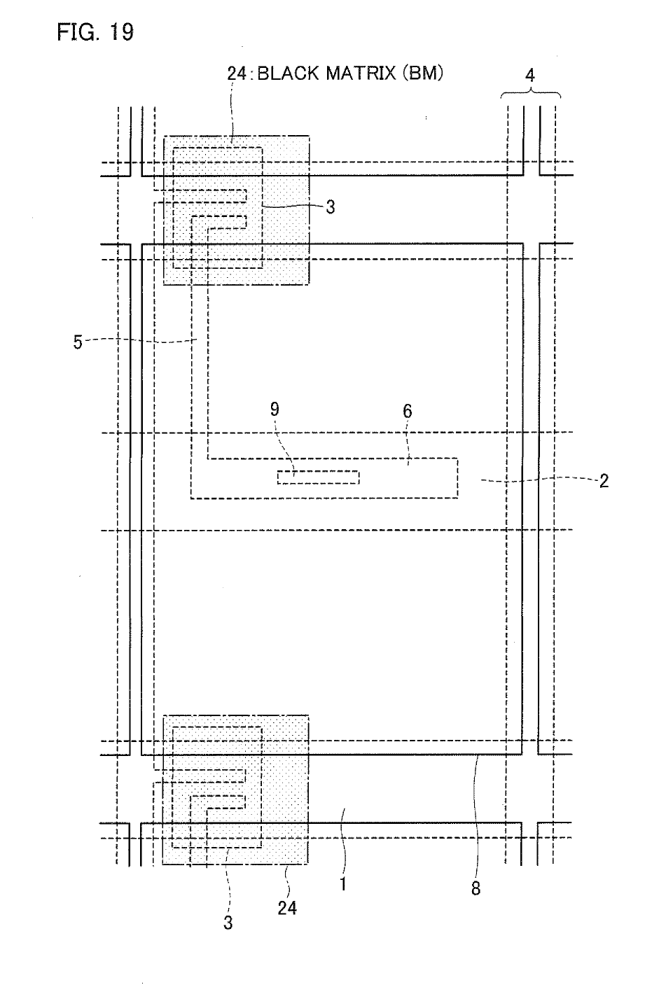

As illustrated in FIG. 19, an island black matrix 24 may be provided only on the TFT element 3, having no MVA slits (slits 12a, 12b, 12c and 12d) which are illustrated in FIG. 18.

An arrangement and a manufacturing method for a liquid crystal panel and a display device including an active matrix substrate and a color filter substrate having the respective arrangements are the same as those of the basic embodiment. Therefore, the descriptions thereof are omitted.

The present embodiment deals with the case where each signal wiring of the first and second panels is made of transparent conductive film. Note however that it is possible to reduce the moire caused by the interference of one signal wiring from the other, provided that at least one of the first and second panels has signal wiring made of transparent conductive film.

The BM is preferably formed in an island shape than a stripe shape. The embodiment deals with the case where each BM of the first and second panels has an island shape. Note however that it is possible to reduce the moire caused by the interference of one BM from the other, provided that at least one of the first and second panels has an island BM.

As mentioned above, it is possible to reduce the moire caused by the interference of one signal line from the other, when at least one of the two panels has signal wiring made of transparent conductive film. It is preferable to further include an island black matrix. This allows a striped BM to be removed, thereby reducing the moire caused by the interference of one BM from the other.

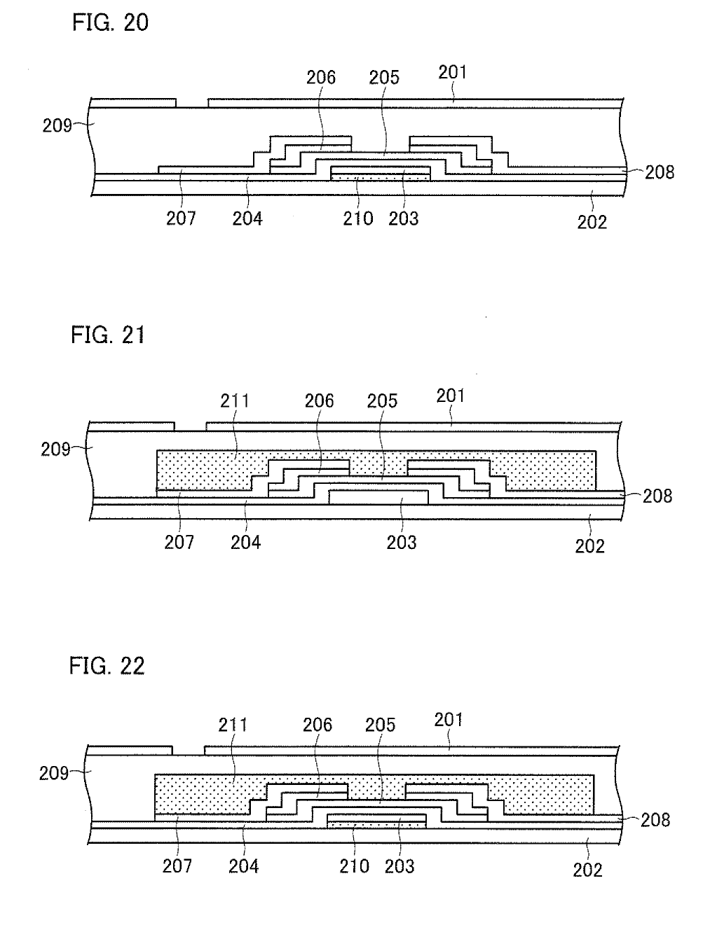

In addition, the backlight source causes off-leakage current of the TFT to increase, since the scan signal line is made of transparent conductive film. Therefore, it is preferable to provide light blocking metal or a resin layer (=BM) directly under the TFT (on the backlight side). This allows a reduction in off-leakage current of the TFT section, as illustrated in FIG. 20.

FIG. 20 illustrates how an active matrix is arranged. Specifically, a gate electrode 203 is formed on a transparent substrate 202 which faces a pixel electrode 201. A gate insulating film 204 is formed so as to cover the gate electrode 203. An active semiconductor layer 205, a low resistance semiconductor 206, data signal wiring 207, and drain lead-out wiring 208 are formed on the gate insulating film 204. Furthermore, an interlayer insulating film 209 is formed between (i) the pixel electrode 201 and (ii) a respective one of the active semiconductor layer 205, the low resistance semiconductor 206, the data signal wiring 207, and the drain lead-out wiring 208.

Additionally in FIG. 20, a black matrix 210 made of a metal film is formed directly under the gate electrode 203.

The black matrix may be arranged so as to be provided on the active matrix substrate (BM on-array) as illustrated in FIG. 21, instead of being on a counter substrate.

Alternatively, the black matrix may be provided on the active matrix substrate so that the TFT section is sandwiched between the black matrix and the active matrix substrate, as illustrated in FIG. 11. That is to say, the black matrix may be arranged such that the semiconductor layer of the TFT section is sandwiched between the black matrix and the active matrix substrate.

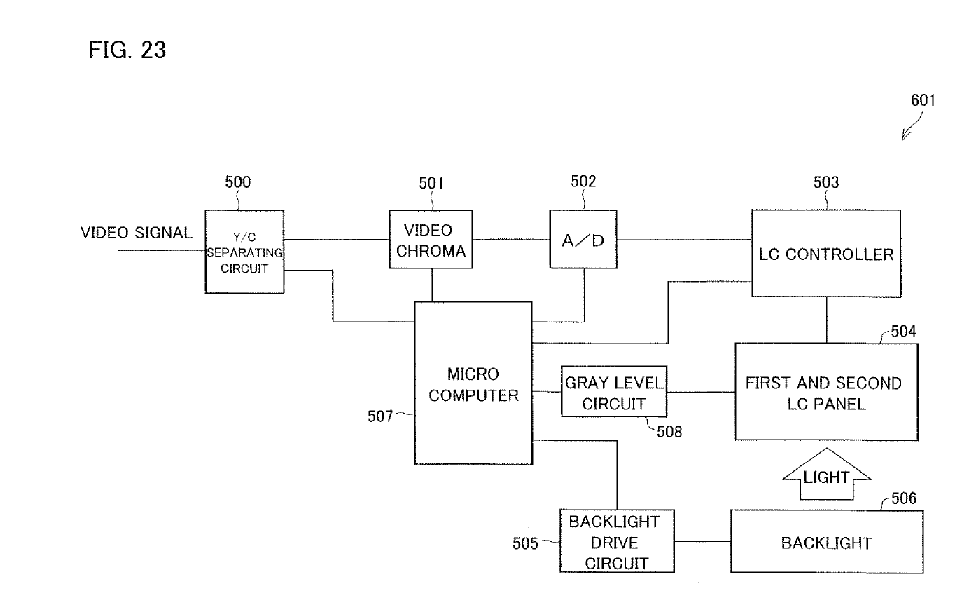

Referring to FIGS. 23 to 25, the following description deals with a television receiver to which the liquid crystal display of the present invention is applied.

FIG. 23 shows a circuit block of a liquid crystal display device 601 for a television receiver.

A liquid crystal display device 601 includes, a Y/C separation circuit 500, a video chroma circuit 501, an A/D converter 502, a liquid crystal controller 503, a liquid crystal panel 504, a backlight drive circuit 505, a backlight 506, a microcomputer 507, and a gray level circuit 508, as illustrated in FIG. 23.

The liquid crystal panel 504 has a double panel structure including a first liquid crystal panel and a second liquid crystal panel. The panels may be of any of the structures described in the foregoing embodiments.

In the above-arranged liquid crystal display device 601, first, an input video signal (television signal) is supplied to the Y/C separation circuit 500 so as to be separated into a luminance signal and a color signal. The luminance signal and the color signal are converted to analog R, G, and B signals (the three primary colors of light), in the video chroma circuit 501. Furthermore, these analog RGB signals are converted to digital RGB signals by the A/D converter 502, which digital RGB signals are supplied to the liquid crystal controller 503.

The liquid crystal panel 504 receives (i) each of the digital RGB signals from the liquid crystal controller 503 at predetermined timing and (ii) respective RGB gray level voltages from the gray level circuit 508. Based on the digital RGB signals and the RGB gray level voltages, the panel 504 carries out an image display. The whole system, including the processes, is controlled by the microcomputer 507.

Various video signals are displayable, which include a video signal based on television broadcast, a video signal representing images captured on a camera, or a video signal supplied over the Internet.

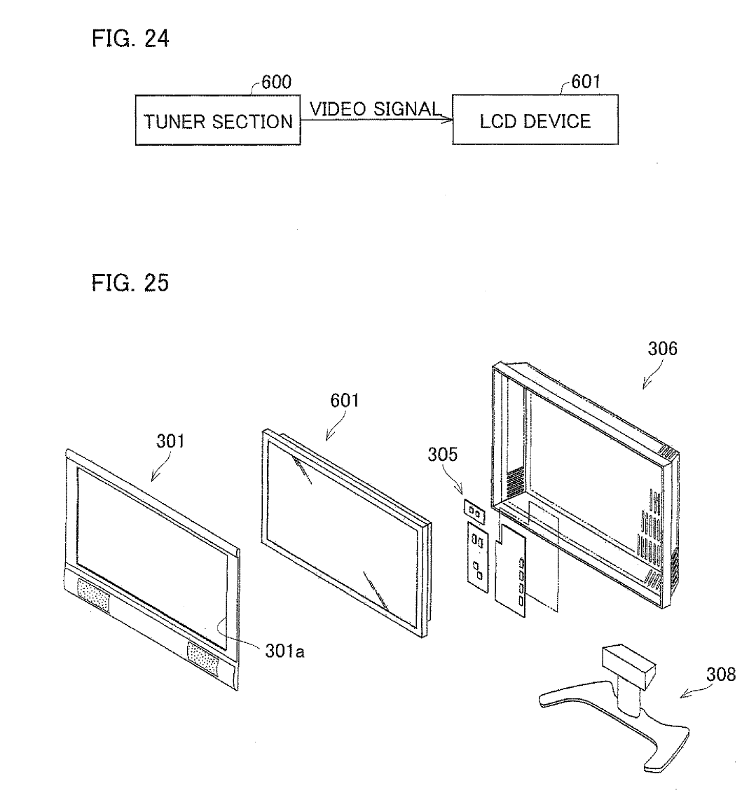

Furthermore, a tuner section 600 illustrated in FIG. 24 receives television broadcast and outputs a video signal. A liquid crystal display device 601 carries out image (video) display based on the video signal supplied from the tuner section 600.

When a liquid crystal display device having the above arrangement is intended to be a television receiver, the liquid crystal display device 601 is packaged so as to be sandwiched between a first housing 301 and a second housing 306, as illustrated in FIG. 25.

The first housing 301 includes an opening 301a which transmits the video so that the video is displayed on the liquid crystal display device 601.

The second housing 306 provides a cover for the backside of the liquid crystal display device 601. The housing 306 is provided with an operation circuit 305 for operation of the liquid crystal display device 601. A supporting member 308 is attached at the bottom of the housing 306.

As described above, when a liquid crystal display device of the present invention is used as a display device in a television receiver having the above arrangement, it is possible to carry out an extremely high quality image display with high contrast and without moire.

The present invention is not limited to the description of the embodiments above, but may be altered by a skilled person in the art within the scope of the claims. An embodiment based on a proper combination of technical means disclosed in different embodiments is encompassed in the technical scope of the present invention.

### INDUSTRIAL APPLICABILITY

The liquid crystal display of the present invention delivers greatly improved contrast and is therefore suitably applicable, for example, to television receivers and broadcast monitors.

1. A liquid crystal display device in which two or more active matrix liquid crystal panels are combined, wherein:
at least one of the two or more liquid crystal panels includes signal wiring made of transparent conductive film.

2. The liquid crystal display device as set forth in claim 1, wherein the two or more liquid crystal panels are first and second liquid crystal panels, and at least one of the first and second liquid crystal panels includes signal wiring formed by a transparent electrode.

3. The liquid crystal display device as set forth in claim 1, wherein each of the liquid crystal panels is sandwiched between polarized light absorbing layers, and polarized light absorbing layers form crossed Nicols.

4. The liquid crystal display device as set forth in claim 1, wherein a light blocking layer is formed on an upper part and/or a lower part of a switching element of an active matrix substrate which constitutes each of the liquid crystal panels.

5. A television receiver comprising:
a tuner section that receives television broadcast; and
a display device that displays the television broadcast received by the tuner section, wherein:
the display device is a liquid crystal display device in which two or more active matrix liquid crystal panels are combined, wherein at least one of the two more liquid crystal panels includes signal wiring made of transparent conductive film
